(19) United States
(12) Patent Application Publication
(10) Pub. No.: US 2019/0191518 A1
(43) Pub. Date: Jun. 20, 2019

(54) SYSTEM AND METHOD FOR CONTROLLING APPLIANCES

(71) Applicants: LUCIS TECHNOLOGIES (SHANGHAI) CO., LTD., Shanghai (CN); LUCIS TECHNOLOGIES HOLDINGS LIMITED, Grand Cayman (KY)

(72) Inventors: Shan GUAN, FREMONT, CA (US); Tao ZHAO, Shanghai (CN); Lin ZHOU, Shanghai (CN); Defeng SHI, Shanghai (CN)

(73) Assignees: LUCIS TECHNOLOGIES (SHANGHAI) CO., LTD., Shanghai (CN); LUCIS TECHNOLOGIES HOLDINGS LIMITED, Grand Cayman (KY)

(21) Appl. No.: 16/326,706

(22) PCT Filed: Aug. 19, 2016
(86) PCT No.: PCT/CN2016/096091

§ 371 Date: Feb. 19, 2019

(51) Int. Cl. H05B 33/08; H05B 37/02

(52) U.S. Cl. CPC H05B 33/0845; H05B 37/0245; H05B 33/0809

(57) ABSTRACT

The present application provides a power regulation circuitry including, a regulation circuit connecting a power supply to a load device, and a computing circuit configured to generate a first control signal when a current conducted through the bidirectional semiconductor is below a threshold level. The regulation circuit may include an optoisolator and a bidirectional semiconductor. The optoisolator may be configured to receive the first control signal from the computing circuit and supply a compensating current to the bidirectional semiconductor to keep the bidirectional semiconductor conductive. The bidirectional semiconductor may be configured to receive, from the optoisolator, a second control signal generated by the computing circuit in response to an input relating to a power delivered to the load device. The present application also provides a control system including a master controller including the power regulation circuitry and a method for controlling a power delivered to a load device.

### TECHNICAL FIELD

The present application relates to a system and method for controlling appliances, and a circuitry within the system configured to adjust the intensity of power delivered to a load device.

### BACKGROUND

Living environment of the modern society often involves the cooperation of multiple appliances including, for example, lights, household electronic appliances (such as refrigerators and televisions), security systems (such as surveillance cameras and alarms), and heat, ventilation, and air conditioning (HVAC) systems, etc. The control of at least some of these electronic devices may involve physical switches. Using physical switches may be inconvenient. There is a need for smart devices and methods for controlling appliances.

### SUMMARY

According to one aspect of the present application, a power regulation circuitry is provided. The power regulation circuitry may include: a regulation circuit connecting a power supply to a load device and a computing circuit configured to generate a first control signal when a current conducted through the bidirectional semiconductor is below a threshold level. The regulation circuit may include an optoisolator and a bidirectional semiconductor. The optoisolator may be configured to receive the first control signal from the computing circuit and supply a compensating current to the bidirectional semiconductor to keep the bidirectional semiconductor conductive. The bidirectional semiconductor may be configured to receive, from the optoisolator, a second control signal generated by the computing circuit in response to an input relating to a power delivered to the load device. According to some embodiments of the present application, the bidirectional semiconductor may be a triode for alternating current (TRIAC).

According to one aspect of the present application, a control system is provided. The control system may include a master controller including the power regulation circuitry regulating power supply to a load device in response to an input relating to a power delivered to the load device. According to some embodiments of the present application, the control system may further include a first slave controller being electrically connected to the master controller and configured to receive the input; and relay the input to the master controller. According to some embodiments of the present application, the control system may further include a second slave controller being electrically connected to the first slave controller and configured to receive the input; and relay the input to the first slave controller.

According to one aspect of the present application, a control method is provided. The method may include one or more of the following operations. A load device may be connected to a power supply to by a regulation circuit including an optoisolator and a bidirectional semiconductor. An input indicating a power delivered to the load device may be received. A first control signal indicative of a compensating current may be generated when a current through the bidirectional semiconductor is below a threshold level. A second control signal indicative of a conduction angle of a phase control power signal may be generated in response to the input. The phase control power signal may be generated for controlling the power delivered to the load device according to the second control signal. According to some embodiments of the present application, the method may further include monitoring the current through the bidirectional semiconductor.

The present application will be further understood in conjunction with the embodiments described below. Without loss of generality, the features and advantages described in the specification are not all-inclusive, and, in particular, many additional features and advantages will be apparent to those skilled in the art in view of the drawings and specification. Moreover, it should be noted that the language used in the specification has been principally selected for readability and instructional purposes, and may not have been selected to delineate or circumscribe the claimed subject matter. The disclosure will be described in detail hereinafter on the basis of several embodiments which are shown in the drawings, however, without the disclosure being restricted thereto.

### BRIEF DESCRIPTION OF THE DRAWINGS

The present application is further described in terms of exemplary embodiments. These exemplary embodiments are described in detail with reference to the drawings. These embodiments are non-limiting exemplary embodiments, in which like reference numerals represent similar structures throughout the several views of the drawings, and wherein:

FIG. 1 shows an exemplary control system according to some embodiments of the present application;

FIG. 2 shows an exemplary master controller according to some embodiments of the present application;

FIG. 3A shows an exemplary communication module according to some embodiments of the present application;

FIG. 3B shows an exemplary input/output interface according to some embodiments of the present application;

FIG. 3C shows an exemplary sensor module according to some embodiments of the present application;

FIG. 4 shows an exemplary slave controller according to some embodiments of the present application;

FIG. 5 shows an exemplary input/output interface according to some embodiments of the present application;

FIG. 6A shows an exemplary connection module of a master controller according to some embodiments of the present application;

FIG. 6B shows an exemplary connection module of a slave controller according to some embodiments of the present application;

FIG. 6C shows an exemplary connector of a master controller according to some embodiments of the present application;

FIG. 6D shows an exemplary connector of a slave controller according to some embodiments of the present application;

FIG. 7 shows an exemplary connection between the connector in a master controller and the connector in a slave controller according to some embodiments of the present application;

FIG. 8 shows an exemplary connection between the connector in a first slave controller and the connector module in a second slave controller according to some embodiments of the present application;

FIG. 9 shows a flowchart of a process for controlling an appliance according to some embodiments of the present application;

FIG. 10 shows a flowchart of a process for controlling an appliance according to some embodiments of the present application;

FIG. 11 is an exemplary block diagram of a control system according to some embodiments of the present application;

FIG. 12 is an exemplary block diagram of a control system according to some embodiments of the present application;

FIG. 13A and FIG. 13B are a first part and a second part of an exemplary schematic diagram of a master controller according to some embodiments of the present application;

FIG. 14 is an exemplary schematic diagram of the master controller according to some embodiments of the present application;

FIG. 15A through FIG. 15I show exemplary waveforms illustrating the operation of a master controller according to some embodiments of the present application;

FIG. 16 shows an exemplary block diagram of a power supply of a master controller according to some embodiments of the present application;

FIG. 17 shows an exemplary flowchart of a control procedure performed by a master controller according to some embodiments of the present application;

FIG. 18 is an exemplary flowchart illustrating a dimming process according to some embodiments of the present application;

FIG. 19 is an exemplary curve illustrating a sinusoid AC waveform according to some embodiments of the present application; and

FIG. 20 is an exemplary curve illustrating a waveform obtained after the sinusoid AC waveform in FIG. 19 is chopped off according to some embodiments of the present application.

### DETAILED DESCRIPTION

In the following detailed description, numerous specific details are set forth by way of examples in order to provide a thorough understanding of the relevant disclosure. However, it should be apparent to those skilled in the art that the present application may be practiced without such details. In other instances, well known methods, procedures, systems, components, and/or circuitry have been described at a relatively high-level, without detail, in order to avoid unnecessarily obscuring aspects of the present application. Various modifications to the disclosed embodiments will be readily apparent to those skilled in the art, and the general principles defined herein may be applied to other embodiments and applications without departing from the spirit and scope of the present application. Thus, the present application is not limited to the embodiments shown, but to be accorded the broadest scope consistent with the claims.

As will be understood by those skilled in the art, the present application may be disclosed as an apparatus (including, for example, a system, device, computer program product, or any other apparatus), a method (including, for example, a computer-implemented process, or any other process), and/or any combinations of the foregoing.

Accordingly, the present application may take the form of an entirely software embodiment (including firmware, resident software, microcode, etc.), an entirely hardware embodiment, or a combination of software and hardware aspects that may generally be referred to herein as a “system.”

It will be understood that the term “system,” “engine,” “module,” “unit,” and/or “block” used herein are one method to distinguish different components, elements, parts, section or assembly of different level in ascending order. However, the terms may be displaced by other expression if they may achieve the same purpose.

It will be understood that when a unit, engine, module or block is referred to as being “on,” “connected to,” or “coupled to” another unit, engine, module, or block, it may be directly on, connected or coupled to, or communicate with the other unit, engine, module, or block, or an intervening unit, engine, module, or block may be present, unless the context clearly indicates otherwise. As used herein, the term “and/or” includes any and all combinations of one or more of the associated listed items.

The devices, modules, units, components or pins with the same numeral or notation in the drawings refers to the same device or components.

The terminology used herein is for the purposes of describing particular examples and embodiments only, and is not intended to be limiting. As used herein, the singular forms “a,” “an,” and “the” may be intended to include the plural forms as well, unless the context clearly indicates otherwise. It will be further understood that the terms “include,” and/or “comprise,” when used in this disclosure, specify the presence of integers, devices, behaviors, stated features, steps, elements, operations, and/or components, but do not exclude the presence or addition of one or more other integers, devices, behaviors, features, steps, elements, operations, components, and/or groups thereof.

Portions of the present disclosure are provided with reference to a dimmer adaptor for dimming, brightening, or turning on/off a light. It is understood that it is for illustration purposes only, and not intended to limit the scope of the application. The description regarding the exemplary embodiments of the dimmer adaptor that may regulate the power to a light (e.g., a light emitting diode (LED) lamp, etc.) is applicable to a power regulation circuitry that may regulate the power to a load device other than a light (e.g., an LED lamp, etc.).

The terms “load,” “load device,” and “electrical load” are used interchangeably herein, to denote an apparatus that may consume electricity and convert it to one or more forms of energy including, for example, mechanical energy, electromagnetic energy, internal energy, chemical energy, or the like, or a combination thereof.

As used herein, the magnitude of power and the intensity of power may be used interchangeably.

Despite the abundance of prospective LED lamp applications, problems still exist in light adjustment techniques that may limit their widespread adoption. One major problem is constant flicker when a traditional dimmer is used with an LED lamp. LED lamps exhibiting less flicker are desirable.

The system and method in the present application may be applied in various environments, such as home, an office, other public or private areas, etc. The system, or referred to as a control system or a load control system, may control one or more devices including, for example, lighting, heating, ventilation and air conditioning (HVAC) appliances, or other appliances, or a combination thereof. The control system may include two kinds of controllers. One kind of controllers may be termed “master controllers.” The other kind of controllers may be termed “slave controllers.” A master controller may control one or more devices in the environment. The slave controller may be connected to or communicated with the master controller in order to control one or more devices.

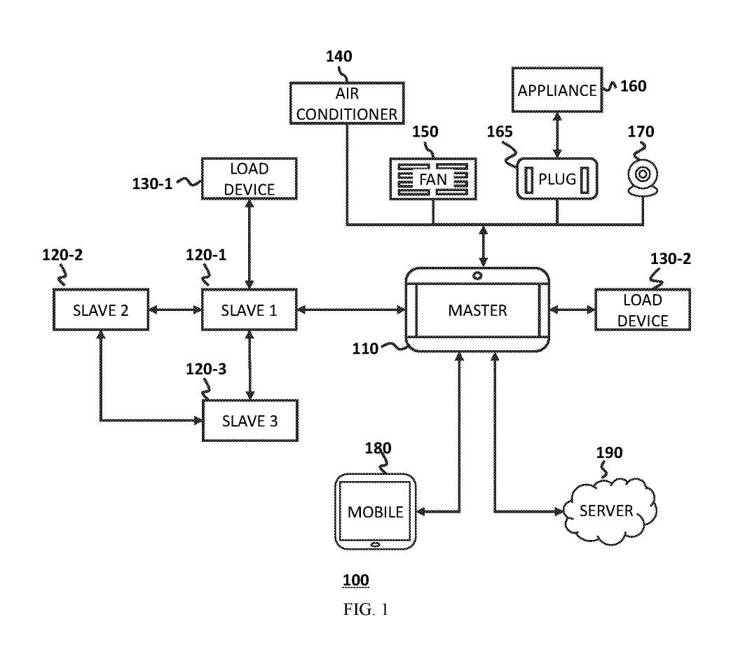

FIG. 1 shows an exemplary control system 100 according to some embodiments of the present application. The control system 100 may include a master controller 110, a plurality of slave controllers (e.g., slave controller 120-1, 120-2, 120-3, . . . , 120-N (not shown)), a plurality of load devices 130 (e.g., load device 130-1, 130-2, . . . , 130-N (not shown)), an air conditioner 140, a fan 150, a plug 165, an appliance 160, a security device 170, a mobile phone 180, and a cloud server 190. The master controller 110 may control, direct, or command one or more load devices 130 and/or one or more of the appliances 140, 150, 160, and 170. In some embodiments, the master controller 110 may be or include a dimmer adaptor or a power regulation circuitry.

The slave controllers 120 may be operably connected to the master controller 110 to allow the control of load devices 130 and the appliances 140 through 170. In some embodiments, the load device 130-1 may be operably connected to the slave controller 120-1, while the load device 130-2 may be operably connected to the master controller 110. As used herein and unless otherwise specifically stated, “operably connected” may refer to the state that relevant elements/components are connected in such a way that they may cooperate to achieve their intended function or functions. The “connection” may be direct, or indirect, physical, remote, via a wired connection, or via a wireless connection, etc.

As illustrated in FIG. 1, the master controller 110 may be in connection with the slave controller 120-1. The slave controller 120-1 may be in connection with the slave controllers 120-2 and 120-3. The slave controller 120-2 may be in connection with the slave controller 120-3.

It should be noted that there may be various connections between one master controller 110 and multiple slave controllers 120-1 through 120-N. The connection between the master controller 110 and slave controllers 120-1 through 120-N may be serial. For example, the master controller 110 may be connected to the slave controller 120-1. The slave controller 120-1 may be further connected to the slave controller 120-2, and so forth. In some embodiments, the master controller 110 may be connected to multiple slave controllers 120-1 through 120-N, forming a network. The network may be chain-like, star-like, branched, or the like, or any combination thereof. The connection between the master controller 110 and multiple slave controllers 120-1 through 120-N may be serial, parallel, or a combination thereof. For instance, the slave controller 120-1 may be connected to more than two slave controllers. In some embodiments, a slave controller 120 may be connected to up to 255 slave controllers.

A user may access the master controller 110 using a mobile device 180. In some embodiments, the master controller 110 may be connected with a cloud server 190 through a network. The network may be a wireless local area network (WLAN), an Ethernet, a wide area network, or the like, or any combination thereof.

The master controller 110 may be placed at a location. Merely by way of example, the master controller 110 may be mounted on the wall or any other appropriate location. For instance, the master controller 110 may be mounted on a wall of the living room. It may be coupled through an electrical connection with one or more slave controllers 120-1 through 120-N. The electrical connections between the master controller 110 and the slave controller 120-1 through 120-N may be based on a wired connection. The master controller 110 may collect information from, or send instructions to one or more load devices 130 or one or more of the appliances 140, 150, 160, and 170. The slave controllers 120-1 through 120-N may be set in different locations in the environment. For instance, if the control system 100 is within a house, the master controller 110 may be set in the living room, and the slave controllers 120-1 through 120-N may be placed in individual rooms including, for example, bedrooms, bathrooms, the kitchen, etc.

The load devices 130 may be any appliance that may consume electricity and/or convert electricity to another form of energy including, for example, mechanical energy (including potential energy, kinetic energy, etc.), internal energy (heat), chemical energy, light, electromagnetic radiation, or the like, or a combination thereof. Exemplary load devices may include a light or lamp, an electric engine, an electric heating device, etc. The light may be a light emitting diode (LED) lamp, a gas discharge lamp (e.g., a neon light), a high-intensity discharge lamp (e.g., a sodium vapor lamp, etc.), a fluorescent lamp such as a compact fluorescent lamp (CFL), an incandescent lamp, an organic light emitting diode (OLED) lamp, an electroluminescent strip, etc. The electric engine may be a motor, or the like. The electric heating device, also referred to as an electric heater, may be in the form of a cooking device, a microwave oven, a fan heater, a convection heater, and so on. Other devices may include a dimmable window, an air conditioner, a refrigerator, a charger, a rechargeable battery, and so on.

In some embodiments, the appliance 160 may establish a communication with the master controller 110 and/or slave controllers 120-1 through 120-N through an electrical connection with the smart plug 165. A smart plug may be a plug or socket that may be connected to a network, for example, a WLAN. The smart plug may be controlled and/or accessed remotely. The electrical connection may be based on an electrical wire or another contact via a conductor. The smart plug 165 may send or receive information through a wireless network such as Bluetooth, WLAN, Wi-Fi, ZigBee, etc. In some embodiments, the appliance 160 may also be in communication with the master controller 110 and/or slave controllers 120-1 through 120-N directly. The communication may be based on a wireless network such as Bluetooth, WLAN, Wi-Fi, ZigBee, etc. For example, an air conditioner may have its WLAN unit and report the monitored temperature and/or power consumption to the master controller 110 through a WLAN in the house.

The security device 170 may include a surveillance camera, an alarm, a smart lock, etc. The security device 170 may monitor the environment and report certain events to the master controller 110. Exemplary events may include somebody approaching or entering through a door, someone entering the back yard, etc. Security device 170 may further receive instructions from the master controller 110 and execute the instructed operations including, for example, locking the door, setting off the alarm, notifying a person (e.g., an owner of a house, etc.) or an entity (e.g., a security department of a building, police, etc.), taking a photo or a video of a suspected person or a suspicious event, etc.

The mobile device 180 may be of any type including, for example, a tablet, a mobile phone, or a laptop, etc. A user may manipulate on the mobile device 180 to change the settings of the master controller 110, to control an electrical device or appliance, to retrieve information (e.g., information relating to energy consumption or the current status of one or more load devices 130 and one or more of the appliances 140, 150, 160, and 170 etc.).

The server 190 may collect and store the data received or collected by the master controller 110. Such data may be historical data or statistical data relating to energy consumption of one or more of load devices 130 and/or one or more of the appliances 140, 150, 160, and 170, behaviors of the user, the operating status of any one of the load devices 130 and the appliances 140, 150, 160, and 170, etc. The data may be analyzed and used for the prediction of the user's behavior in the future. In some embodiments, the master controller 110 may retrieve historical data from the server 190. In some embodiments, the server 190 may be a cloud server.

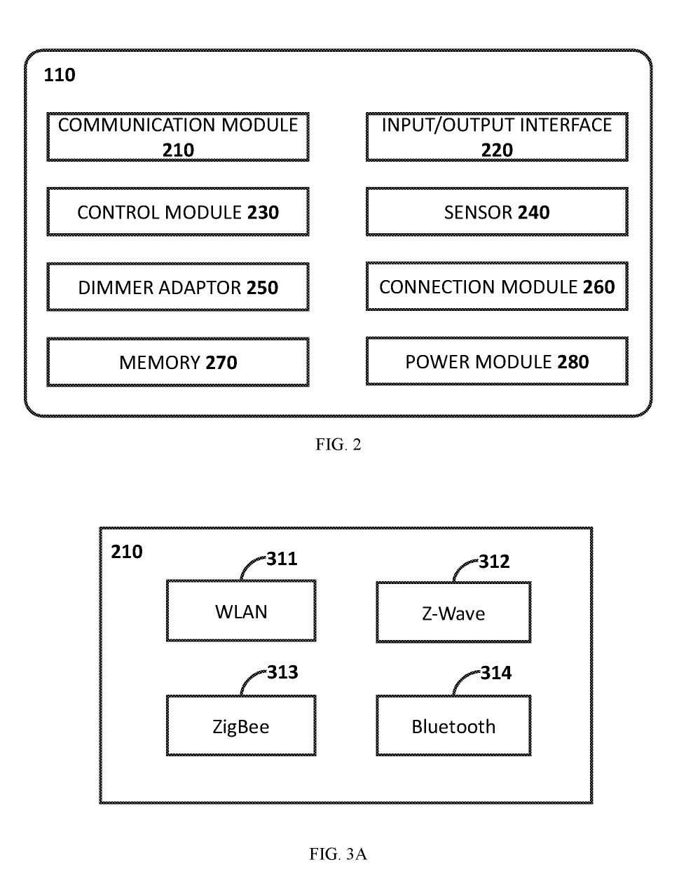

FIG. 2 is an exemplary block diagram of a master controller 110 according to some embodiments of the present application. It should be noted that the master controller 110 described below is merely provided for illustration purposes, and not intended to limit the scope of the present application.

As illustrated in FIG. 2, the master controller 110 may include one or more of a communication module 210, an input/output interface, a control module 230, a sensor 240, a dimmer adaptor 250, a connection module 260, a memory 270, and a power module 280.

The communication module 210 may facilitate the master controller 110 to communicate with a user, an appliance, a slave controller 120, etc. In some embodiments, the communication may be achieved wirelessly. In some embodiments, the master controller 110 may use the communication module 210 to receive information relating to the operation of an appliance from a slave controller 120 or a smart household appliance. A smart household appliance may refer to a home appliance or electronics that may be connected to a network and/or controlled remotely. In some embodiments according to the present application, the communication module 210 may receive information from one or more slave controllers 120. Also, the master controller 110 may send information including, for example, an order or instruction, to a slave controller 120 through the communication module 210. Further, in some embodiments, the communication module 210 may communicate with the memory 270. The communication may be realized by exchanging radiofrequency signals between the communication module 210 and the memory 270. The radiofrequency signals may be stored, in the form of data, in the memory 270. Data in the memory 270 may be processed by the master controller 110 and/or read by the slave controller 120.

The input/output interface 220 may allow a user to interact with the master controller 110. In some embodiments, the input/output interface 220 may be used to receive information, merely by way of example, an order or instruction, from the user. In some embodiments, the received information may be further sent to the control module 230. In some other embodiments, the input/output interface 220 may present a message to the user. For example, the input/output interface 220 may provide or show a message to the user notifying whether an order has been executed accordingly or not. Further, in some embodiments, the input/output interface 220 may be controlled by a user via a wired connection or a wireless connection. With respect to the wired control, a cable based network may be employed including, for example, an Ethernet connection, or a ring network connection, or the like, or any combination thereof. With respect to wireless control a wireless network may be employed including, for example, a WLAN network, an NFC network, a ZigBee network, a Z-wave network, an infrared communication network, a network provided by one or more mobile network operators, or the like, or any combination thereof. For instance, a user may access the input/output interface 220 remotely with a cellphone, a tablet, a laptop, a remote control, or the like, or a combination thereof. In some embodiments, the input/output interface 220 may include or communicate with a touch screen through which the user may control, interact with, and/or input instructions to the input/output interface 220 by touching a particular area of the input/output interface 220. However, the control panel may take another form including, for example, a panel with a movable component, or the like, or a combination thereof. The movable component may be a bar, a dial, a button, a key, or the like, or a combination thereof. The movable component may be slidable, rotatable, clickable, or the like, or a combination thereof. In some embodiments, the input/output interface 220 may include or communicate with a remote control. In some embodiments, the remote control may communicate with the dimmer adaptor 250 wirelessly.

The control module 230 may process data received from an appliance (e.g., any one of the load devices 130 and the appliances 140, 150, 160, and 170), the input/output interface 220, the sensor 240, the slave controller 120, the cloud server 190, etc. The data may relate to controlling the operation of an appliance including, for example, any one of the load devices 130 and the appliances 140, 150, 160, and 170. In some embodiments, the control module 230 may include a processor (not shown) to decode, decipher, manipulate, or analyze the received data. In some embodiments, the received data and/or processed data may be transferred to the memory 270. The received data and/or the processed data may be sent to an appliance (e.g., any one of the load devices 130 and the appliances 140, 150, 160, 170, etc.), the mobile device 180, the server 190, etc., by the communication module 210. Merely by way of example, the control module 230 may be a central processing unit (CPU), an application-specific integrated circuit (ASIC), an application-specific instruction-set processor (ASIP), a graphics processing unit (GPU), a physics processing unit (PPU), a microcontroller unit (MCU), a digital signal processor (DSP), a field programmable gate array (FPGA), an advanced RISC (reduced instruction set computing) machines (ARM), or the like, or any combination thereof.

In some embodiments, the control module 230 may be powered by an independent power source other than the power supply that powers the rest of the master controller 110. This arrangement may keep the control module 230 intact of the power failures in some extreme situations.

The sensor 240 may detect or monitor parameters relating to the ambient environment. Exemplary parameters may include physical data, chemical data, biological data, etc. The physical data may relate to the temperature, light, motion, vibration, pressure, humidity, image, fingerprint, or the like, or any combination thereof. The chemical data may relate to the concentration of a gas or other chemicals in the air, etc. The gas or chemicals in the air may include carbon monoxide, carbon dioxide, oxygen, hydrogen sulfide, ammonia, particle matters, etc. The biological data may be related to the blood pressure, heart rate, pulse rate, concentration of blood sugar or insulin, or any combination thereof. The sensor 240 may send the detected or monitored parameters to the control module 230 for further processing. In some embodiments, the sensor 240 is an external device, not belonging to the master control 110 or the control system 100; the external sensor 240 may communicate with the master control 110 or the control system 100 via, for example, the communication module 210.

The dimmer adaptor 250 may control the load device 130 in the control system 100. In some embodiments, the dimmer adaptor 250 may include a dimmer circuit (not shown). The dimmer adaptor 250 may adjust the power delivered to the load device 130. For instance, the load device 130 includes a light; the adjustment of the power supplied to the light may result in variation of illuminance of the light. Merely by way of example, the dimmer adaptor 250 may turn the load device 130 on or off. In some embodiments, the dimmer adaptor 250 may control the illumination intensity of the load device 130 according to the instruction of a user.

In some embodiments, the dimmer adaptor 250 may utilize a phase control power signal to control the intensity of the power delivered to the load device 130. Exemplary phase control power signals may include a forward phase control power signal, a reverse phase control power signal, or the like, or a combination thereof. A forward phase control power signal may be generated by varying the conduction angle of the second half of a half-cycle of an AC input voltage. A reverse phase control power signal may be generated by varying the conduction angle of the first half of a half-cycle of an AC input voltage. A conduction angle may refer to the angle at which the phase control power signal begins to be conducted. Alternatively, the dimmer adaptor 250 may utilize a pulse width modulation (PWM) signal to control the intensity of the power delivered to the load device 130. Further, in some embodiments, the dimmer adaptor 250 may include a communication component through which the dimmer adaptor 250 may communicate with the input/output interface 220. It is to be noted that the above description of the dimmer adaptor 250 is provided merely for illustration purposes, and not intended to limit the scope of the present application. The communication component may be unnecessary. For instance, the dimmer adaptor 250 may be connected or communicate with the input/output interface 220 directly. The connection or communication between the dimmer adaptor 250 and the input/output interface 220 may be via a wired connection or a wireless connection. The wireless connection or communication may be a Bluetooth connection, a ZigBee connection, a Z-wave connection, a Wi-Fi or WLAN connection, a near field communication (NFC), an infrared connection, etc.

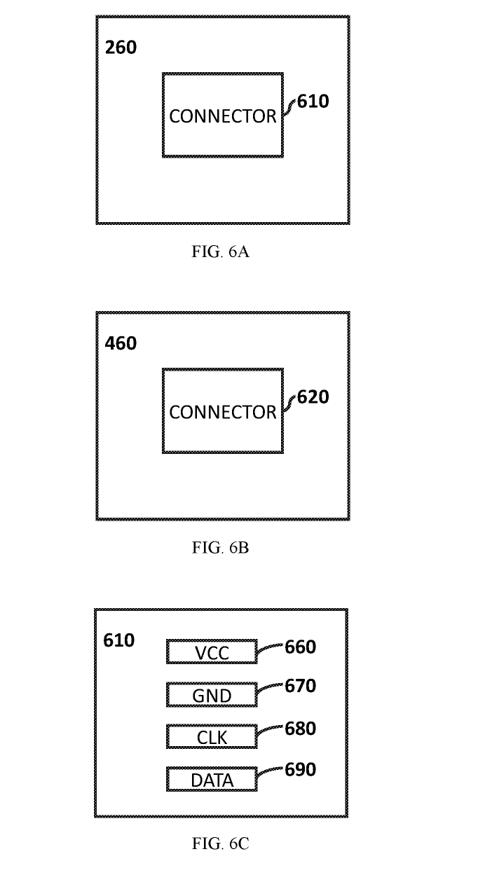

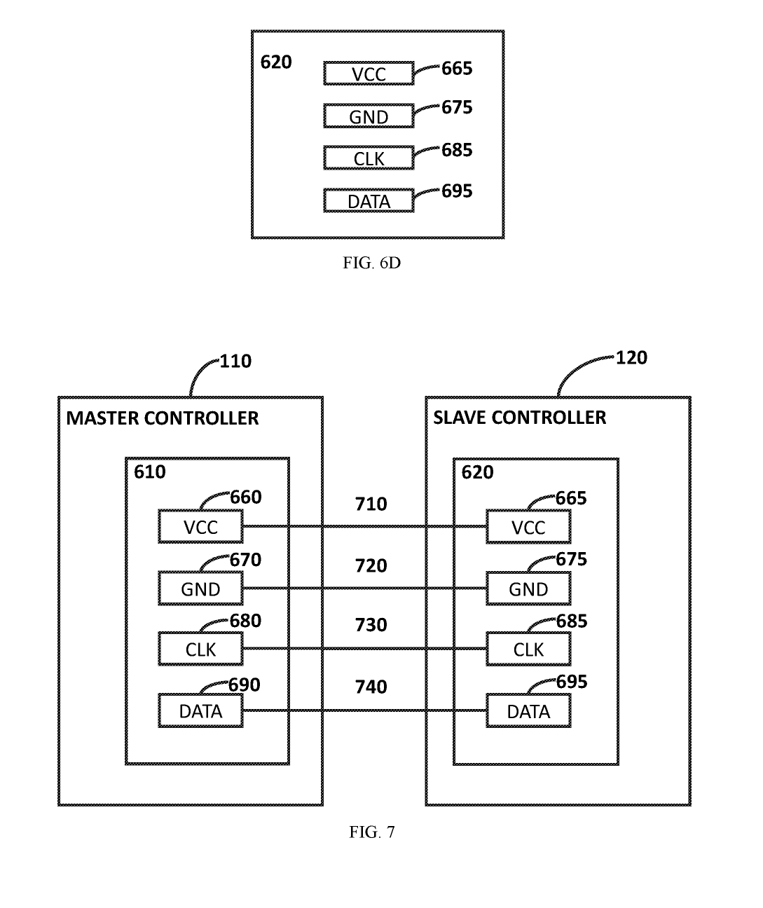

The connection module 260 may connect the master controller 110 with a slave controller 120 in a wired or wireless way. In some embodiments, the connection module 260 may provide power to the slave controllers 120, and/or receive information relating to operation of the appliances from the slave controllers 120, or a combination thereof. In some embodiments, the connection module 260 may send information or instruction relating to operation of the appliances to the slave controller 120. In some embodiments, the connection module 260 may include a connector. See, for example, FIG. 6C for the detailed description of the connector 610.

The memory 270 may store the information relating to the operation of an appliance. In some embodiments, the information may be an input from a user, a slave controller 120, a server (e.g., the server 190), or the like, or any combination thereof. The information may relate to the operation of an appliance including, for example, the power supply, the operation schedule, etc. In some embodiments, the input may relate to an intensity of power delivered to a load device. In some embodiments, the information received by the master controller 110 may be from a slave controller 120. In some embodiments, a slave controller 120 may send the information to another slave controller 120. Merely by way of example, a second slave controller 120 may send a received information to a first slave controller 120. The first slave controller 120 that has received the information may then transfer or relay the received information to the master controller 110.

The power module 280 may provide power to an energy consuming device including, for example, a master controller 110, a slave controller 120, a smart household appliance, or the like, or any combination thereof. In some embodiments, the power module 280 may be coupled with an interface that may present the energy consumption data to a user. The data may relate to the energy consumption of a time point or for a period including, for example, current power consumption, daily/weekly/monthly/annual consumption of energy, etc. The user may manage the energy consumption, e.g., the energy consumption within a specific time period, for example, a day, a week, a month, or a year.

The power module 280 may be powered by an external power source. In some embodiments, there may be various choices of the power source. For example, the power source may be a typical household power outlet. As another example, the power source may be any type of power supply including, for example, a direct current (DC) power supply, an AC power supply, a switched-mode power supply, a programmable power supply, an uninterruptible power supply (UPS), a high voltage power supply, or the like, or a combination thereof. The power supply may be a DC power supply or an AC power supply, while other forms of power supply, such as the switched-mode power supply may also be used. There may be two or more power supplies. When there are multiple power supplies, the types of power supplies may be the same or different. For example, there may be a DC power supply and an AC power supply; there may be two DC power supplies.

In some embodiments, the power module 280 may include a power inverter that may convert an alternating current into a direct current. In some embodiments, the voltage of the alternating current may range from 85 to 265 V. In some embodiments, the power module 280 may support several states of operation including, for example, a normal operation state, an operation in a low energy state, an operation in a lowest energy mode (e.g., the energy consuming device is turned off), etc.

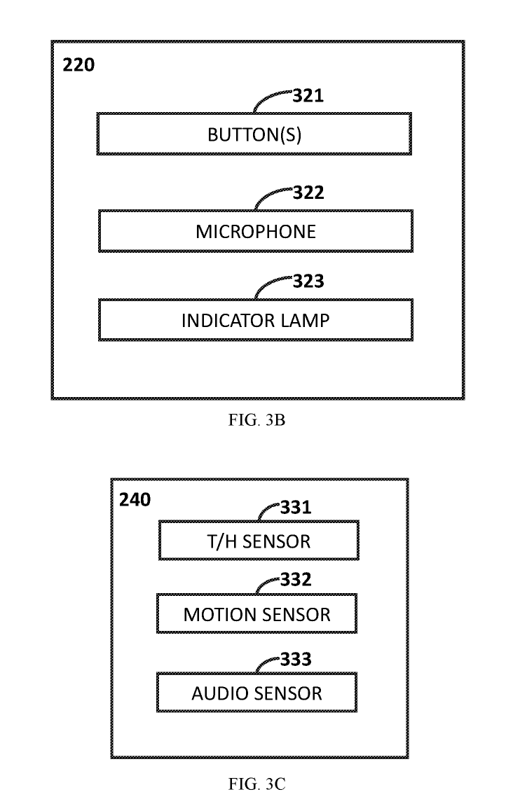

FIG. 3A shows an exemplary communication module 210 according to some embodiments of the present application. As shown in FIG. 3A, the communication module 210 may include a WLAN unit 311, a Z-wave unit 312, a ZigBee unit 313, and a Bluetooth unit 314. The communication module 210 may support a WLAN communication, a Z-wave communication, a ZigBee communication, or a Bluetooth communication. It should be noted that the communication module 210 may have one or more any other communication units. For example, a unit for radiofrequency communication other than WLAN, Z-wave, ZigBee, and Bluetooth may also be used in the communication module 210.

FIG. 3B shows an exemplary input/output interface 220 according to some embodiments of the present application. As shown in FIG. 3B, the input/output interface 220 may include any one of button(s) 321, a microphone 322, and an indicator lamp 323. A user may use the button(s) 321 or the microphone 322 to provide information relating to an appliance to the master controller 110. In some embodiments, the information may be provided by the user pressing the button(s) 321. In some embodiment, the information may take the form of an audio input by the user. For example, the input/output interface 220 may receive the information in the form of an audio input by the user through the microphone 322. The indicator lamp 323 may be used to notify the user of certain information relating to an alarm, a state of operation, etc. In some embodiments, a specific color of the indicator lamp 323 may be representative of a specific state of the master controller 110. Merely by way of example, the indicator lamp 323 may emit green light when the controller 110 operates normally, and red light when it operates abnormally. The indicator lamp 323 may take the form of a light emitting diode (LED) lamp, a gas discharge lamp (for example, a neon lamp, etc.), an incandescent lamp, or any other light emitting device or component.

It should be noted that the above description is for illustration purposes only. For a person having ordinary skill in the art, based on the contents and principle of the present application, the form and details of the input/output interface 220 may be modified or changed without departing from certain principles. For example, the button(s) 321 may be replaced by one or more of a slide bar, a knob, a dial, or the like, or a combination thereof. Correspondingly, the user may slide the slide bar, or rotate the knob or dial to provide information. As another example, the indicator lamp 323 may be replaced by a display, such as a LED display, an OLED display, or an electronic ink display. Such modification or changes are still within the scope of the present application.

FIG. 3C shows an exemplary sensor 240 according to some embodiments of the present application. As shown in FIG. 3C, the sensor 240 may include a temperature/humidity (T/H) sensor 331, a motion sensor 332, an audio sensor 333, or the like, or a combination thereof. The temperature/humidity (T/H) sensor 331 may detect the temperature/humidity in the ambient environment and send the temperature/humidity data to the control module 230. In some embodiments, the control module 230 may determine a security level when the detected temperature/humidity exceeds a threshold. As used herein, “exceeding a threshold” may include being higher than a threshold, or lower than a threshold. In some embodiments, the threshold may be preset by a user. In some embodiments, the motion sensor 332 may collect the information in the form of an image including, for example, a still image (photo) or a video. In some embodiments according to the present application, the motion sensor 332 may take the form of an image sensor. The image sensor may be a coupled charge device (CCD) sensor, a complementary metal oxide semiconductor (CMOS) sensor, a passive infrared sensor, an infrared reflective sensor, etc. In some embodiments according to the present application, the motion sensor 332 may take the form of a microwave sensor, an ultrasonic sensor, a tomographic motion detector, etc. The audio sensor 333 may collect an audio signal including, for example, noise, sound (e.g., ambient sound), human or animal voice, etc. In some embodiments, one or more of the sensors may coordinate with each other. Merely by way of example, the motion sensor 332 and the audio sensor 333 may coordinate to obtain a video signal and a corresponding audio signal. As another example, the signal from one sensor may trigger the detection of a signal by another sensor. For instance, an image signal indicating an event (e.g., a person crossing the fence in the backyard of a house) may trigger the detection of an audio signal in that area.

In some embodiments, the sensor 240 is an external device, not belonging to the master control 110 or the control system 100; the external sensor 240 may communicate with the master control 110 or the control system 100 via, for example, the communication module 210.

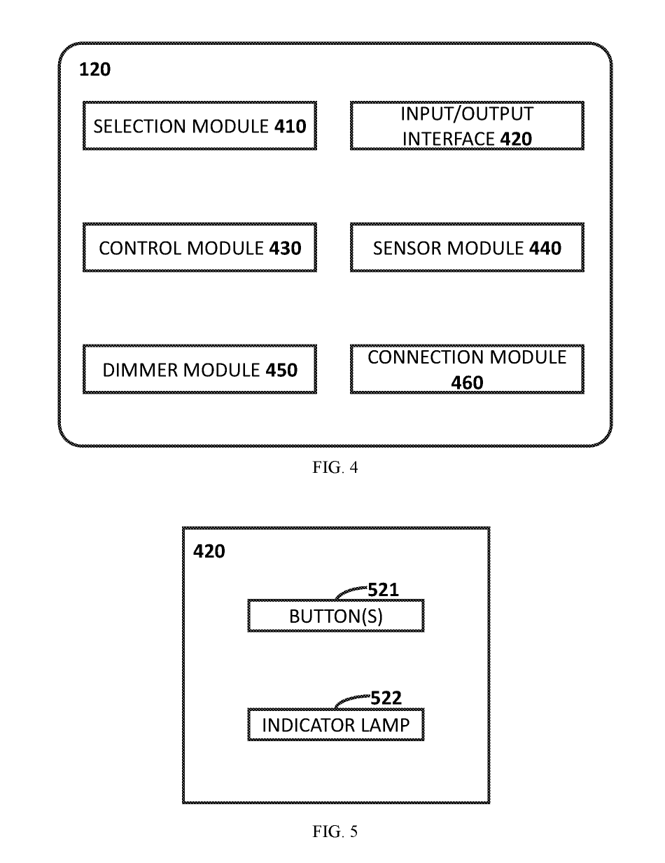

FIG. 4 shows an exemplary slave controller 120 according to some embodiments of the present application. It should be noted that the slave controller 120 described below is merely provided for illustration purposes, and not intended to limit the scope of the present application.

As illustrated in FIG. 4, the slave controller 120 may include at least one of a selection module 410, an input/output interface 420, a control module 430, a sensor 440, a dimmer adaptor 450, and a connection module 460.

The sensor 440 in the slave controller 120 may be similar to the sensor 240 in the master controller 110. The description of the sensor 240 is applicable to the sensor 440 and not repeated. Likewise, the dimmer adaptor 450 may be similar to the dimmer adaptor 250 in the master controller 110. The description of the dimmer adaptor 250 is applicable to the dimmer adaptor 450 and not repeated.

With reference to FIG. 4, the control module 430 in the slave controller 120 may process data received from one or more of a user, the input/output interface 420, the sensor 440, another slave controller 120, etc. The control module 430 may send the processed data to the master controller 110, or one or more other slave controller 120, or any combination thereof. In some embodiments, the control module 430 may include a processor (not shown) to decode or process the received data. Merely by way of example, the control module 430 may be a central processing unit (CPU), an application-specific integrated circuit (ASIC), an application-specific instruction-set processor (ASIP), a graphics processing unit (GPU), a physics processing unit (PPU), a microcontroller unit (MCU), a digital signal processor (DSP), a field programmable gate array (FPGA), an advanced RISC (reduced instruction set computing) machines (ARM), or the like, or any combination thereof.

In some embodiments, the slave controller 120 may include the control module 430. Some processing of the information collected by the slave controller 120 may be performed by the slave controller 120, while some processing of the information collected by the slave controller 120 may be performed by the master controller 110. Merely by way of example, the control module 430 in the slave controller 120 may convert an analog signal, such as the rotating of a brightness control knob for a light, to a digital one. The digital signal indicating a brightness value may be sent to the master control 110 by the slave controller 120. The corresponding power delivered to the light and the phase-cutting may be determined by the control module 230 in the master controller 110.

In some embodiments, a slave controller 120 does not include the control module 430. Information collected by the slave controller 120 may be forwarded to the master controller 110 to be processed. In some embodiments, an instruction generated accordingly by the master controller 110 may be provided to the slave controller 120 to be executed by the slave controller 120. In some embodiments, an instruction generated accordingly by the master controller 110 may be executed by the master controller 110. Merely by way of example, after receiving an input to dim a light, the slave controller may relay the input to a master controller. The master controller may generate an instruction designating a power delivered to the light according to the input. The master controller may send the instruction to the slave controller. The slave controller may execute the instruction and control the power delivered to the light. In some embodiments, the master controller may execute the instruction itself, without sending the instruction to the slave controller.

The selection module 410 may select one or more slave controllers 120 from a plurality of slave controllers 120. The slave controller 120, on which the selection module 410 is implemented, may be connected to the slave controller(s) 120 that has/have been selected. The selection module 410 may coordinate the communication among multiple slave controllers 120. Merely by way of example, when the slave controller 120-1 needs to connect to the slave controller 120-2, the selection module 410 of the slave controller 120-1 may first send a request signal to the slave controllers 120-2. The slave controllers 120-2 through 120-N that receive the request signal may send a reply signal to the slave controller 120-1 from which the request signal was sent. The selection module 410 of the slave controller 120-1 may make a decision on which slave controller 120, e.g., the slave controller 120-2 in the example, to select based on the reply signal.

The connection module 460 may allow the slave controller 120 to connect with the master controller 110 or other slave controller 120 in the control system 100. In some embodiments according to the present application, the connection module 460 may allow the slave controller 120 to receive information from another slave controller 120. The received information may be further sent to the master controller 110 by the connection module 460. In some embodiments, the connection module 460 may allow the slave controller 120 to receive information and/or instruction relating to operation of an appliance from a master controller 110. In some embodiments, the connection module 460 may include one or more connectors 620, each of the connector 620 may be connected to a slave connector 620 or a master connector 610. Further, the connection module 460 may receive power from the master controller 110. The power may be an alternating current (AC) or a direct current (DC). In some embodiments, the AC may have a voltage within the range from 85 to 265 V. The AC may have a frequency, for example, 50 Hz, 60 Hz, or any other frequency.

The input/output interface 420 may allow a user to interact with the slave controller 120. In some embodiments, the input/output interface 420 may be used to receive information including, for example, an input relating to the power delivered to a load device, from the user. The received order may be sent to the control module 430 and be processed. In some embodiments, the input/output interface 420 may send a message to the user. For example, the input/output interface 420 may provide or show a message to notify the user whether the order has been executed normally or not.

FIG. 5 is an exemplary input/output interface 420 according to some embodiments of the present application. As shown in FIG. 5, the input/output interface 420 may include any one of button(s) 521 and an indicator lamp 522. The user may use the button(s) 521 to provide information to the master controller 110. In some embodiments, the information may be provided by the user pressing the button(s) 521. The indicator lamp 522 may be used to notify the user of the state of the slave controller 120. In some embodiments, the indicator lamp 522 may emit a light that represents a specific state of the slave controller 120. Merely by way of example, the indicator lamp 522 may emit green light when the slave controller 120 operates normally, and red light when it operates abnormally. The indicator lamp 522 may take the form of a light emitting diode (LED) lamp, a gas discharge lamp (for example, a neon lamp), an incandescent lamp, or any other light emitting device or component.

It should be noted that the above description is for illustration purposes only. For a person having ordinary skill in the art, based on the content and principle of the present application, the form and details of the input/output interface 420 may be modified or changed without departing from certain principles. For example, the button(s) 521 may be replaced by one or more slide bar, knob, dial, or the like, or a combination thereof. Correspondingly, the user may slide the slide bar, or rotate the knob or dial to provide information. As another example, the input/output interface 420 may include one or more other input/output features including, for example, a microphone, etc. Such modification or changes are still within the scope of the present application as defined by the claim.

FIG. 6A shows an exemplary connection module 260 of the master controller 110 according to some embodiments of the present application. The connection module 260 may include one or more connector 610. See, for example, FIG. 6C for the detailed description of the connector 610.

FIG. 6B shows an exemplary connection module 460 according to some embodiments of the present application. The connection module 460 may include one or more connector 620. See, for example, FIG. 6D for the detailed description of the connector 620.

FIG. 6C shows an exemplary connector 610 within the connection module 260 of the master controller 110 according to some embodiments of the present application. The connector 610 may include four pins, a pin VCC 660, a pin GND 670, a pin CLK 680, and a pin DATA 690. The master controller 110 may be connected to a slave controller 120 by one or more of these or other pins. The connector 610 may have more than four pins. For example, the connector 610 may have two pin VCC 660, two pins GND 670, two pins CLK 680, and/or two pins DATA 690. The pin VCC 660 in the connector 610 may be connected to a positive voltage to maintain a high potential. The pin VCC 660 in the connector 610 of the master controller 110 may further provide a high voltage to the slave controller 120 that is in connection with the master controller 110. The pin GND 670 in the connector 610 may be connected to a ground. The pin CLK 680 and the pin DATA 690 in the connector 610 of the master controller 110 may allow a connection between the master controller 110 and one or more slave controllers 120. The connection may include an inter-integrated circuit (I2C), a universal asynchronous receiver/transmitter (UART) communication, or the like, or a combination thereof. The pin CLK 680 in the connector 610 of the master controller 110 may generate a clock signal and initiate communication with a slave controller 120. The pin DATA 690 in the connector 610 of the master controller 110 may transmit data to or receive data from a slave controller 120.

FIG. 6D shows an exemplary connector 620 in the connection module 460 according to some embodiments of the present application. The connector 620 of the connection module 460 may establish an electrical connection with a connector 610 of the connection module 260 in a master controller 110, or a connector 620 of the connection module 460 in another slave controller 120. The connector 620 may include four pins, a pin VCC 665, a pin GND 675, a pin CLK 685 and a pin DATA 695. The connection module 460 to be connected to a master controller 110 or another slave controller 120 by one or more of these or other pins. The connector 620 may have more than four pins. For example, two pins VCC 665, two pins GND 675, two pins CLK 685 and/or two pins DATA 695. The pin VCC 665 in the connector 620 may receive a high voltage from the master controller 110 in connection with the slave controller 120. The pin GND 675 in the connector 620 may be connected to the ground. The pin CLK 685 and the pin DATA 695 in the connector 620 of the slave controller 120 may allow a connection between the slave controller 120 and one master controllers 110 or one or more other slave controllers 120. The connection may include an I2C or UART communication, or the like, or a combination thereof. The pin CLK 685 in the connector 620 of the slave controller 120 may receive a clock signal from and initiate communication with a master controller 110. The pin DATA 695 in the connector 620 of the slave controller 120 may transmit data to or receive data from a master controller 110.

FIG. 7 shows an exemplary connection between the connector 610 of the connection module 260 in one master controller 110 and the connector 620 of the connection module 460 in one slave controller 120 according to some embodiments of the present application. The master controller 110 may be in electrical connection with the slave controller 120. Specifically, the pin VCC 660 in the master controller 110 may be electrically connected by the connection 710 to the pin VCC 665 in the slave controller 120 to keep the master controller 110 and slave controller 120 remain at the same voltage. The voltage may be a DC voltage, for example, 12 V (volts), 7.4 V, 5 V, or any other suitable voltage. The voltage may be generated and outputted by the power module 280 in the master controller 110. The pin GND 670 in the master controller 110 may be in electrical connection 720 with the pin GND 675 in the slave controller 120. In some embodiments, the pin GND 670 in the master controller 110 may be connected to the ground. Thus, the pin GND 675 in the slave controller 120 and the pin GND 670 in the master controller 110 may also have the same potential. The connections 710 and 720 may be realized through an electric wire.

The pin CLK 680 in the master controller 110 may be in an electrical connection 730 to the pin CLK 685 in the slave controller 120. The connection 730 may allow the slave controller to receive a clock signal generated by the control module 230 of the master controller 110. Based on the clock signal, the slave controller 120 may perform one or more of the operations including, for example, initialization, recovery, resetting, synchronization with the master controller 110, etc. The pin DATA 690 in the master controller 110 may be in an electrical connection 740 to the pin DATA 695 in the slave controller 120. The connection 730 may allow the transmission of information. The information may relate to a user interaction, for example, a touch on the button(s) 521 by a user. The user interaction may relate to an operation of an appliance including, for example, dimming or brightening a light, lowering the fan speed of an air conditioner, etc. The flow of information may be from the slave controller 120 to the master controller 110, or vice versa. In some embodiments, the information that is sent from the slave controller 120 to the master controller 110 may be collected by another slave controller 120 previously. The connections 730 and 740 may be realized through an electrical wire, a twisted cable wire, an optical cable, etc.

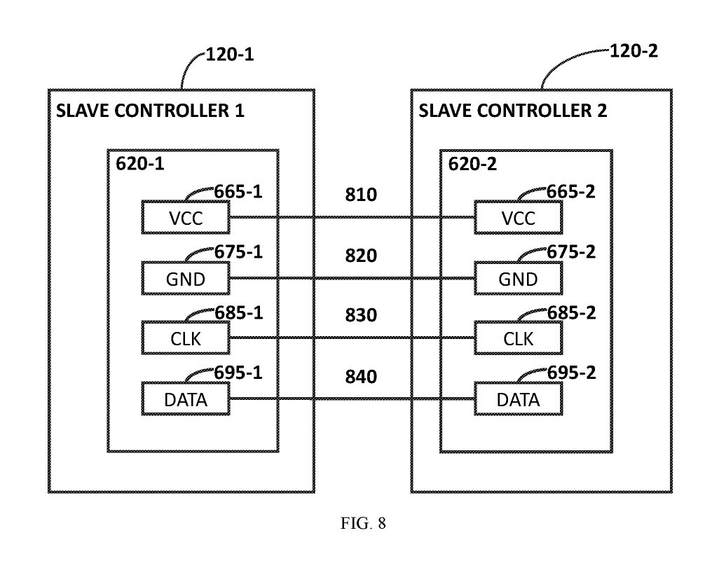

FIG. 8 shows an exemplary connection between the connector 620-1 in one slave controller 120-1 and the connector 620-2 in another slave controller 120-2 according to some embodiments of the present application. The slave controller 120-1 may be in electrical connection with the slave controller 120-2. Specifically, the pin VCC 665-1 in the slave controller 120-1 may be in electrical connection 810 with the pin VCC 665-2 in the slave controller 120-2. In some embodiments, the pin VCC 665-1 in slave controller 120-1 or 665-2 in slave controller 120-2 may be further connected to a pin VCC 660 in a master controller 110 to keep the master controller 110 and slave controllers 120-1 and 120-2 remain at the same voltage, as FIG. 7 shows. The voltage may be a DC voltage, for example, 12 V (volts), 7.4 V, 5 V, or any other suitable voltage. The voltage may be generated and outputted by the power module 280 in the master controller 110. The pin GND 675-1 in the slave controller 120-1 may be in electrical connection 820 with the pin GND 675-2 in the slave controller 120-2. In some embodiments, the pin GND 675-1 in slave controller 120-1 or 675-2 in slave controller 120-2 may be connected to a pin GND 670 in a master controller 110. The pin GND 670 may be further connected to the ground. Thus the pins GND 675-1, 675-2 and 670 may have the same potential. The connections 810 and 820 may be realized through an electric wire.

The pin CLK 685-1 in the slave controller 120-1 may be in an electrical connection 830 to the pin CLK 685-2 in the slave controller 120-2. The pin CLK 685-1 or 685-2 may be further connected to a pin CLK 680 in a master controller 110, as FIG. 7 shows. The connection 830 may allow the slave controllers 120-1 and/or 120-2 to receive a clock signal generated by the control module 230 of the master controller 110. Based on the clock signal, the slave controller 120-1 and/or 120-2 may perform one or more of the operations including, for example, initialization, recovery, resetting, synchronization with the master controller 110, etc. The pin DATA 695-1 in the slave controller 120-1 may be in an electrical connection 840 to the pin DATA 695-2 in the slave controller 120-2. The pin DATA 695-1 or 695-2 may be further connected to a pin DATA 690 in a master controller 110, as FIG. 7 shows. The connection 830 may allow the transmission of information. The information may relate to a user interaction, for example, a touch on the button(s) 521 by a user. The user interaction may relate to an operation of an appliance including, for example, dimming or brightening a light, lowering the fan speed of an air conditioner, etc. The flow of information may be from the slave controller 120-1 to the slave controller 120-2, or vice versa. The slave controller 120-2, to which the information flows, may send the received information to either the master controller 110 or another slave controller 120-3. The connections 830 and 840 may be realized through an electrical wire, a twisted cable wire, an optical cable, etc. The connections 830 and 840 may be the same or different.

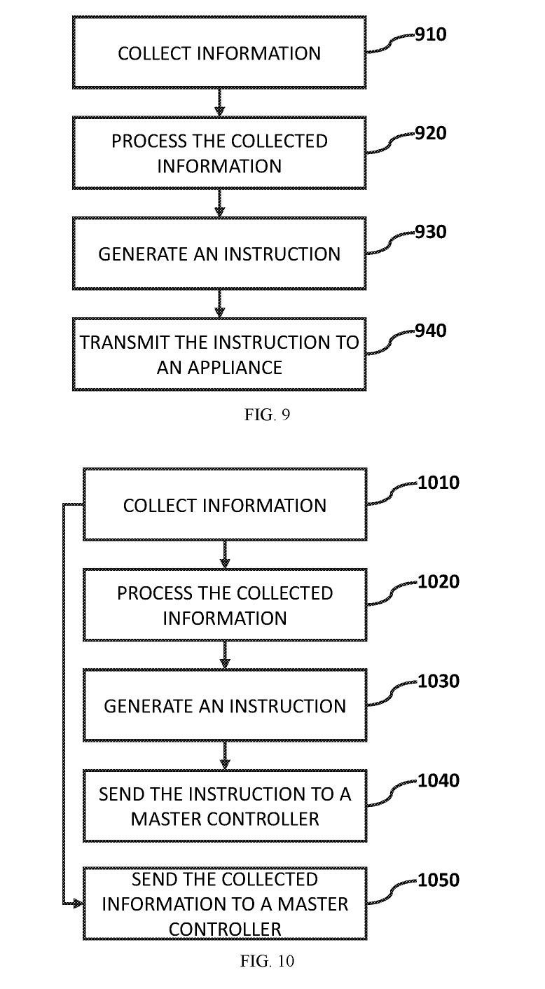

FIG. 9 shows an exemplary flowchart of a process for controlling an appliance according to some embodiments of the present application.

In step 910, the master controller 110 may collect information relating to the operation of an appliance. Such information may include turning on or off the appliance, adjusting the power consumption of the appliance, changing the working mode of the appliance, setting an operation schedule for the appliance, etc. The information may be collected from the input/output interface 220 of the master controller 110 itself, or from a slave controller 120 through the connection 740, as FIG. 7 shows.

In step 920, the collected information may be processed by, for example, the control module 230 of the master controller 110. The processing may include, for example, calculating a characteristic value based on the collected information, recognizing a pattern from the collected information, or analyzing the collected information, etc. In some embodiments, the characteristic value may relate to the power consumption or a working time of the appliance, such as, a light, an air conditioner, and so on. In some embodiments, the analysis of the information may generate a result relating to the working or operation of the appliance, such as, determining a working mode or operation schedule of the appliance.

After the processing of collected information, the master controller 110 may generate an instruction relating to the operation of the appliance in step 930. The generation of the instruction may be carried out by the control module 230. The instruction may include setting the power of the appliance to a desired value, changing the working mode of the appliance, setting an operation schedule for the appliance, etc.

In step 940, instructions generated in the master controller 110 may be transmitted to the appliance that is to be controlled. The transmission may be via the communication module 210. The transmission of the instruction may be wireless or wired. The wireless transmission may be based on various technologies including, for example, Bluetooth, ZigBee, Z-wave, WLAN as defined in the IEEE 802.11 series standards, infrared, etc. The wired transmission may be based on an electrical wire, a twisted cable wire, an optical cable, etc. In some embodiments, the instruction may be encrypted for transmission.

It should be noted that the above description on the control of appliances by the master controller 110 is for illustration purposes only, and not intended to limit the scope of the present application. For a person having ordinary skill in the art, based on the content and principle of the present application, the steps and details of the appliance control may be modified or changed without departing from certain principles. For example, the master controller 110 may generate an instruction to control the appliance without processing the collected information. Thus the step 920 may be omitted. As another example, the master controller 110 may receive a feedback from the controlled appliance after the transmission of the instruction. These modifications and changes are still within the scope of the present application as defined the claims.

FIG. 10 shows an exemplary flowchart of a process for controlling an appliance according to some embodiments of the present application.

In step 1010, a slave controller 120-1 may collect information relating to the operation of an appliance. Such information may include, turning on or off the appliance, adjusting the power delivered to the appliance, changing the working mode of the appliance, setting an operation schedule for the appliance, etc. The information may be collected from the input/output interface 420 of the slave controller 120-1 itself, or from another slave controller 120-2 through the connection 840, as FIG. 8 shows. In some embodiments, the information may take the form of pressing the button 521 by the user.

In step 1020, the collected information may be processed by, for example, the control module 430 of the slave controller 120-1. The processing may include, for example, calculating a characteristic value from the collected information, recognize a pattern from the collected information, or analyzing the collected information, etc. In some embodiments, the characteristic value may relate to the power delivered to or a working time of the appliance, such as, a light, an air conditioner and so on. In some embodiments, the analysis of the information may generate a result relating to the working or operation of the appliance, such as, determining a working mode or operation schedule of the appliance.

After the processing of collected information, the slave controller 120-1 may generate an instruction relating to the operation of the appliance in step 1030. The generation of the instruction may be carried out by the control module 430. The instruction may include setting the power of the appliance to a desired value, changing the working mode of the appliance, setting an operation schedule for the appliance, etc.

In step 1040, the connection module 460 in the slave controller 120-1 may send the generated instruction to a master controller 110 that is controlled with the slave controller 120-1, or to another slave controller 120-3. In some embodiments, the slave controller 120-3 may send the generated instruction to the master controller 110. The transmission of the instruction from the slave controller 120-1 to the master controller 110 may be through the connection 740 between the pin DATA 695 in the slave controller 120-1 and the pin DATA 690 in the master controller 110, as FIG. 7 shows. The transmission of the instruction from the slave controller 120-1 to another slave controller 120-3 may be through the connection 840 between the pin DATA 695-1 in the slave controller 120-1 and the pin DATA 695-3 in the slave controller 120-3. In some embodiments, the instruction may be encrypted for transmission.

In some embodiments, the slave controller 120-1 may simply send the collected information to the master controller 110 or another slave controller 120-3 in step 1050, without processing with the control module 430. The steps 1020 through 1040 may be skipped. In some embodiments, the slave controller 120-3 may send the collected information to the master controller 110. The transmission of the collected information from the slave controller 120-1 to the master controller 110, may be through the connection 740 between the pin DATA 695 in the slave controller 120-1 and the pin DATA 690 in the master controller 110, as FIG. 7 shows. The transmission of the collected information from the slave controller 120-1 to another 120-3, may be through the connection 840 between the pin DATA 695-1 in the slave controller 120-1 and the pin DATA 695-3 in the controller 120-3. In some embodiments, the instruction may be encrypted for transmission.

It should be noted that the above description on the control of appliances by the slave controller 120-1 is for illustration purposes only, and not intended to limit the scope of the present application. For a person having ordinary skill in the art, based on the content and principle of the present application, the steps and details of the appliance control may be modified or changed without departing from certain principles. For example, in step 1040, the slave controller 120-3 may send the generated instruction to another slave controller 120-N rather than the master controller 110. The slave controller 120-N may then send the received instruction to the master controller 110. These modifications and changes are still within the scope of the present application as defined in the claims.

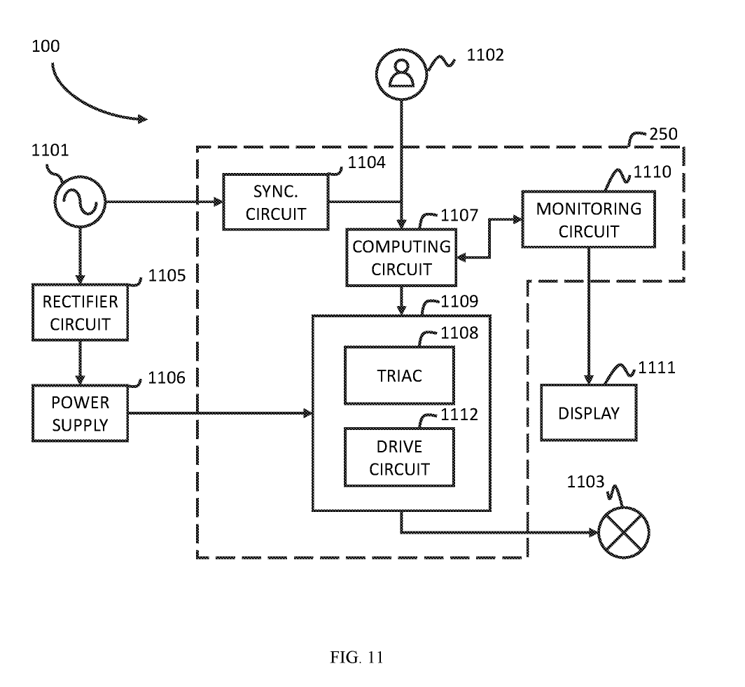

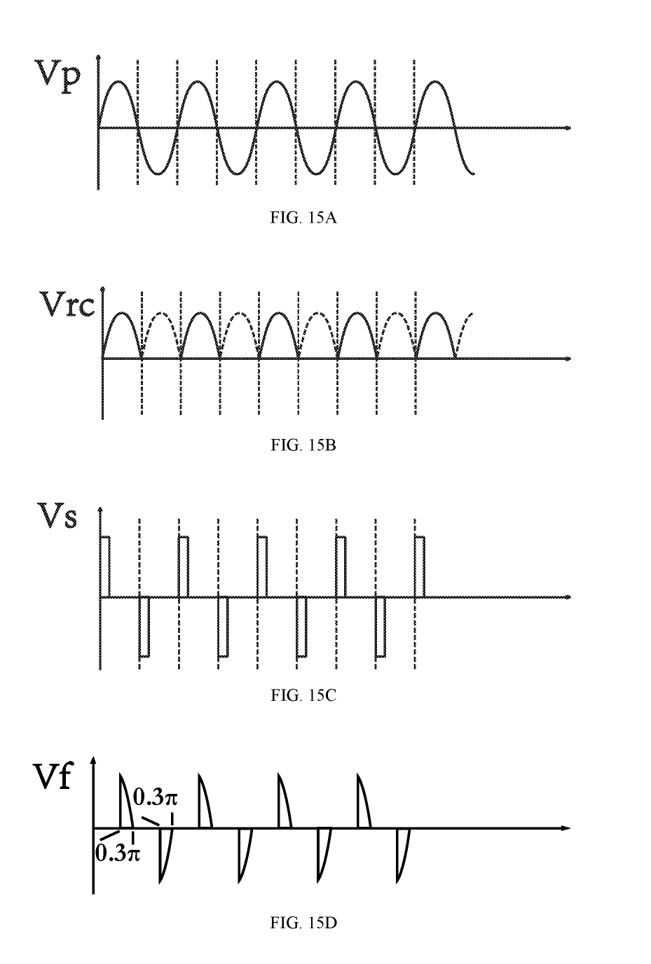

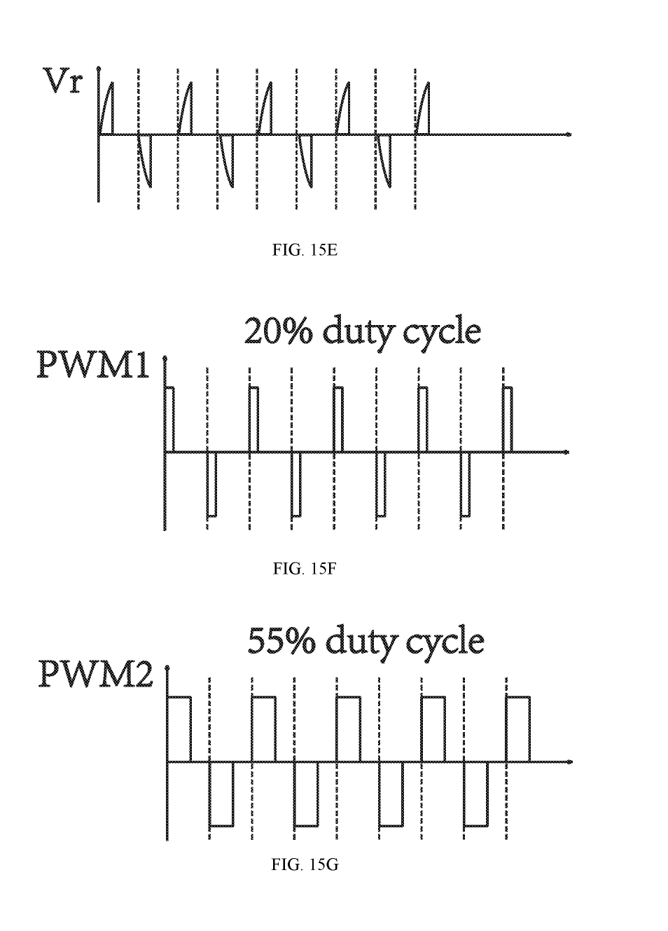

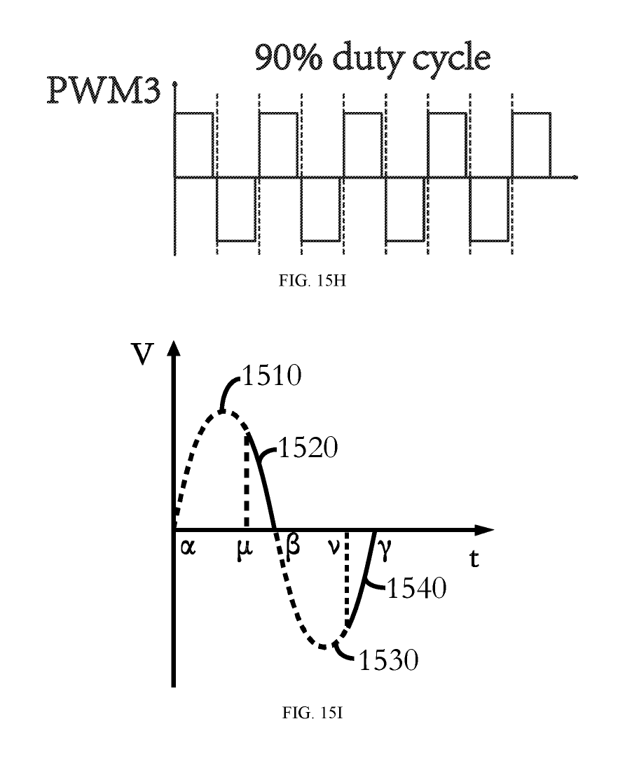

FIG. 11 is an exemplary block diagram of the control system 100 including the dimmer adaptor 250 according to some embodiments of the present application. As specified in FIG. 11, the control system 100 may include a dimmer adaptor 250, a rectifier circuit 1105, a power supply 1106, and a display 1111. The control system 100 may be connected to a power source 1101 and a load device 1103. The dimmer adaptor 250 may include a synchronization circuit 1104, a computing circuit 1107, a regulation circuit 1109 and a monitoring circuit 1110. In some embodiments, the computing circuit 1107 may include several timers (not shown in FIG. 11) built in for counting. A power source 1101 may supply an AC input voltage to the synchronization circuit 1104 in the dimmer adaptor 250. In some embodiments, the AC input may have a waveform as shown in FIG. 15A (Vp). The power source 1101 may be a residential, commercial, or an industrial electrical power source, etc. Some examples of the AC input voltage may include a 60 Hz/110 V line voltage in the United States of America, a 50 Hz/220 V line voltage in Europe, a 50 Hz/220 V line voltage in China, etc. Based on the AC input voltage, the synchronization circuit 1104 may output a timing signal that may indicate the zero-crossing points of the AC input voltage (FIG. 15C, Vs). In some embodiments of the present application, the timing signal may indicate the zero-crossing points of the AC input voltage by generating a pulse signal with a desired duty cycle ranging from 0 to 100%. As illustrated in FIG. 15C, a pulse signal (Vs) may be generated corresponding to a zero-crossing point of the input AC voltage (Vp in FIG. 15A). The direction of the AC input voltage may be indicated by either a positive pulse signal or a negative pulse signal. Alternatively, the timing signal may indicate the occurrence of the zero-crossing points without indicating the direction of the AC input voltage (Vp). In some embodiments, the timing signal may indicate only the occurrence of inclining zero-crossing points when the AC input voltage changes from a negative amplitude to a positive amplitude and intersects with the time axis. In some embodiments, the timing signal may indicate only the occurrence of declining zero-crossing points when the AC input voltage changes from a positive amplitude to a negative amplitude and intersects with the time axis. The timing signal may also include any of combination of the zero-crossing points described above.

The rectifier circuit 1105 may regulate the AC input voltage from the power source 1101, producing a DC power. The DC power may be a half-wave power or a full-wave power (FIG. 15B, Vrc). The DC power may be supplied to the power supply 1106 which, in turn, may transform the power of the DC voltage to a desired magnitude. For example, the power supply 1106 may output a voltage of 7.4 V, a 5 V, a 3.3 V, or the like. The computing circuit 1107 may be powered by the output power of the power supply 1106.

In some embodiments, a control signal may be inputted by a user 1102 via a control panel. In some embodiments, the control signals may be inputted directly via the dimmer adaptor 250 by a remote control (not shown in the figure). In some embodiments, the control signal may be generated based on instructions stored in, for example, a computer or another device that may communicate with or be part of the control system 100. Merely by way of example, the instruction may specify a condition and a corresponding control signal to be generated, as described elsewhere in the present application.

Merely by way of example, the load device 1103 is an LED lamp. Exemplary control signal may include a signal of dimming the LED lamp 1103, brightening the LED lamp 1103, turning on/off the LED lamp 1103, etc. Alternatively, the control signal may be an indication signal representing the luminous intensity of the LED lamp 1103, for example, indicating dimming the LED lamp 1103 to a certain luminance, for example, 500 millicandela. The control signal may be a signal relating to a value by which the luminous intensity is sampled and measured with a particular format. For example, if the value of the luminous intensity of the LED lamp 1103 falls in the range between 0 and 100 changing in increment of 1, the user 1102 may adjust the LED lamp 1103 to a desired value within the range. For another type of a load device 1103 other than an LED lamp, the control signal may include, for example, a signal to reduce the power to the load device 1103, a signal to increase the power to the load device 1103, an initiation signal to turn on the load device 1103, a termination signal to turn off the load device 1103, or the like, or any combination thereof.

Based on a control signal, the computing circuit 1107 may generate a phase controlled signal or a PWM signal (as shown in FIG. 15F through FIG. 15H). In some embodiments, the phase controlled signal or the PWM signal may be utilized to adjust the power intensity delivered to the LED lamp 1103.

The regulation circuit 1109 may connect the power supply 1106 to the LED lamp 1103. The regulation circuit 1109 may include a TRIAC 1108 and a drive circuit 1112. In some embodiments, the TRIAC 1108 and the drive circuit 1112 may be integrated in a single device. The drive circuit 1112 may drive the TRIAC 1108.

The computing circuit 1107 may control the regulation circuit 1109, in particular, the drive circuit 1112. The computing circuit 1107 may be an IC with a certain number of pins. One or more pins of the IC may be coupled with one or more electronic devices. Alternatively, the computing circuit 1107 may be a central processing unit (CPU), an application-specific integrated circuit (ASIC), an application-specific instruction-set processor (ASIP), a graphics processing unit (GPU), a physics processing unit (PPU), a microcontroller unit (MCU), a digital signal processor (DSP), a field programmable gate array (FPGA), an advanced RISC (reduced instruction set computing) machines (ARM), or the like, or any combination thereof. In some embodiments, the computing circuit 1107 may include several timers (not shown in FIG. 11) built in for counting purposes. In some embodiments, the computing circuit 1107 and the regulation circuit 1109 may be integrated in a single printed circuit board (PCB). In some embodiments, the computing circuit 1107 may be powered by a power source other than the power supply 1106. This arrangement may protect the computing circuit 1107 from situations including, for example, power failure.

The monitoring circuit 1110 may be coupled with the regulation circuit 1109 or, in particular, with the TRIAC 1108, or the drive circuit 1112. The monitoring circuit 1110 may monitor current conducted through the regulation circuit 1109 continuously or at regular or irregular time intervals by the current conducted through the TRIAC 1108 or the drive circuit 1112. The monitoring circuit 1110 may amplify the monitored current based on an amplification signal from the computing circuit 1107. The amplification signal may indicate initializing the amplification, stopping the amplification, amplifying the monitoring current with a desired gain, weakening the monitoring current with a desired gain, etc. The monitoring circuit 1110 may supply information to the display 1111. Exemplary information may include the magnitude of the monitored current, for example, 5 micro ampere (mA). The display 1111 may be a liquid crystal display (LCD). The display 1111 may be on or part of a control panel. However, other types of displays such as, an LED display, an OLED display, an electronic paper display, an electroluminescent display, and so on, may also be utilized.

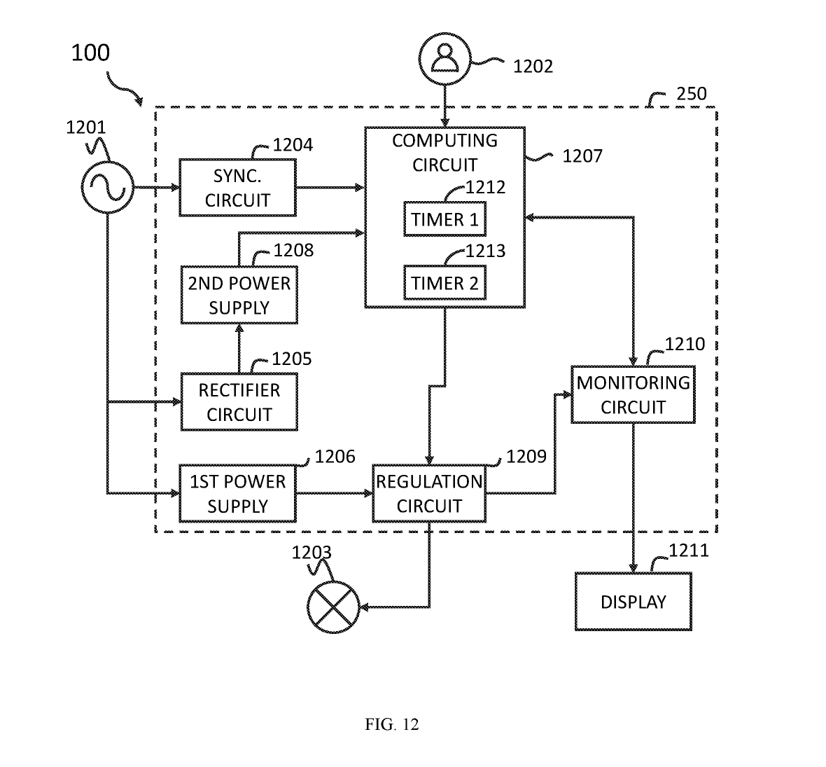

FIG. 12 is a block diagram of the control system 100 including the dimmer adaptor 250 according to some embodiments of the present application. The load device 130 may include an LED lamp 1203 as illustrated in FIG. 12. In some embodiments, the control system 100 may also include a display 1211. The dimmer adaptor 250 may include a synchronization circuit 1204, a computing circuit 1207, a regulation circuit 1209, and a monitoring circuit 1210. In some embodiments the dimmer adaptor may also include a first power supply 1206, a second power supply 1208, a rectifier circuit 1205, etc. The regulation circuit 1209 may connect the power supply 1206 to the LED lamp 1203.

As illustrated in FIG. 12, the power source 1201 may include an AC voltage source that may supply an AC input voltage to a synchronization circuit 1204, a rectifier circuit 1205, and/or a first power supply 1206. The AC voltage source may be a residential electric power source, a commercial electric power source, or an industrial electric power source, or the like, or any combination thereof. Some examples of the AC input voltage may include a 60 Hz/110 V line voltage in the United States of America, a 50 Hz/220 V line voltage in Europe, a 50 Hz/220 V line voltage in China, etc.

The computing circuit 1207 may be a processor. The processor may be an IC with a certain number of pins corresponding to, for example, pins 0 through 15. One or more pins of the IC may be coupled with one or more electronic devices. Alternatively, the computing circuit 1207 may be a central processing unit (CPU), an application-specific integrated circuit (ASIC), an application-specific instruction-set processor (ASIP), a graphics processing unit (GPU), a physics processing unit (PPU), a microcontroller unit (MCU), a digital signal processor (DSP), a field programmable gate array (FPGA), an advanced RISC (reduced instruction set computing) machines (ARM), or the like, or any combination thereof. The computing circuit 1207 may include several timers, for example, timer 1 1212 and time 2 1213. Timer 1 1212 and time 2 1213 may be used for counting.

The synchronization circuit 1204 may receive the AC input voltage from the power source 1201 and generate a timing signal that may indicate a zero-crossing point and the direction (or phase) of the AC input voltage (as illustrated in FIG. 15A through FIG. 15H). As used herein, a zero-crossing point may be the point at which the waveform of the AC input voltage intersects with the time axis and the corresponding amplitude of the AC input voltage is 0. In some embodiments, the timing signal may be provided to the computing circuit 1207 for estimating or determining the AC input voltage.

In some embodiments of the present application, the timing signal may indicate the zero-crossing points of the AC input voltage when the zero-crossing point is encountered in the AC input voltage. The timing signal generated by the synchronization circuit 1204 may include a pulse signal with a desired duty cycle ranging from 0 to 100%. As used herein, a duty cycle may refer to the percentage of one period in which the pulse signal is active. As illustrated in FIG. 15C, the pulse signal (Vs) may be generated immediately after the corresponding zero-crossing points of the input AC voltage (Vp); the direction of the AC input voltage may be indicated by either a positive pulse signal or a negative pulse signal. As used herein, “immediately” may indicate that the interval between two events is less than a threshold, for example, 0.1 millisecond. Alternatively, the timing signal may indicate the time of a zero-crossing point without indicating the direction (or phase) of the AC input voltage (Vp) at the time. In some embodiments, the timing signal may indicate inclining zero-crossing points only. As used herein, an inclining zero-crossing point may refer to a zero-crossing point encountered when the AC input voltage changes from a negative amplitude to a positive amplitude and intersects with the time axis. In some embodiments, the timing signal may indicate declining zero-crossing points only. As used herein, a declining zero-crossing point may refer to a zero-crossing point encountered when the AC input voltage changes from a positive amplitude to a negative amplitude and intersects with the time axis. In some embodiments, the timing signal may include both inclining zero-crossing points and declining zero-crossing points.

Additionally or alternatively, the power source 1201 may also supply the AC input voltage to the rectifier circuit 1205 so that the AC input voltage may be transformed into a DC power to drive one or more of a variety of electronic components. The DC power may be a half-wave power or a full-wave power (for example, Vrc in FIG. 15B). The power source 1201 may supply an AC input voltage to the first power supply 1206. The first power supply 1206 may transform the AC input voltage into the power of a first magnitude of power. In some embodiments, the regulation circuit 1209 may be powered and conducted by the power of the first magnitude. The first magnitude of the power may be an AC voltage including, for example, 3.3 V, 5 V, 7.4 V, 110 V, 120 V, 220 V, 240 V, or any other appropriate voltage. In some embodiments, the second power supply 1208 may be a power source independent of the power source 1201, for example, a battery, an electric generator. In some embodiments, the second power supply 1208 may process the DC power from the power supply 1201 and transform the DC power into the power of a second magnitude. The computing circuit 1207 may be driven by the power of the second magnitude. The second magnitude of the power may be a 7.4 V voltage, a 5 V voltage, a 3.3 V voltage, or any other appropriate voltage.

A user 1202 may adjust the luminous intensity of the LED lamp 1203 by adjusting a light actuator embedded inside a control panel. Based on the user input, the light actuator may generate a control signal. The control signal may be transmitted to the computing circuit 1207. Based on the control signal, the computing circuit 1207 may control the regulation circuit 1209 so that the power of a desired magnitude may be delivered to the LED lamp 1203.

The monitoring circuit 1210 may monitor the power delivered to the regulation circuit 1209. The monitoring may be performed real time. The monitoring may be performed continuously, periodically, or irregularly. For instance, the monitoring may be performed continuously when the LED lamp 1203 is on. As another example, the monitoring may be performed every 5 seconds, or every 10 seconds, or every 15 seconds, or every 20 seconds, or every 30 seconds, or every minute, or every 2 minutes, etc. The monitoring circuit 1210 may adjust the magnitude of the power based on, for example, the power consumption of the LED lamp 1203. The LED lamp 1203 is used here as an exemplary load device. The monitoring circuit 1210 as disclosed herein may be used to monitor power consumption of another load device. The power consumption may be calculated based on, for example, the current through and the voltage across the lamp 1203. In some embodiments, the power consumption data may be displayed on the display 1211. The monitoring circuit 1210 may adjust (e.g., amplify or reduce) the amplitude of the current to the LED lamp 1203 (or referred to as the monitored current) to generate a measurable current based on an amplification signal from the computing circuit 1207. The amplification signal may indicate, for example, initializing the monitoring, stopping the monitoring, resuming the monitoring, amplifying the monitored current with a desired gain, etc. Merely by way of example, if the monitored current is too weak to be measured with an acceptable accuracy, the monitored current may be amplified with a gain so that the monitored current may be measured with the acceptable accuracy. The computing circuit 1207 may provide a compensating current to the regulation circuit 1209 when the monitoring circuit 1210 identifies that the current delivered to the regulation circuit 1209 drops below a threshold level.

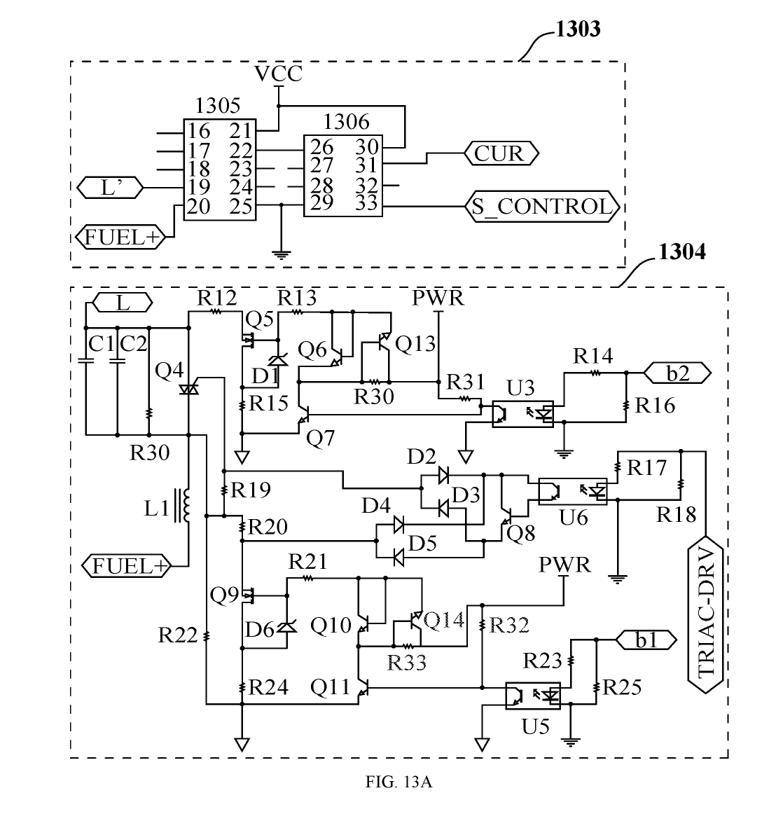

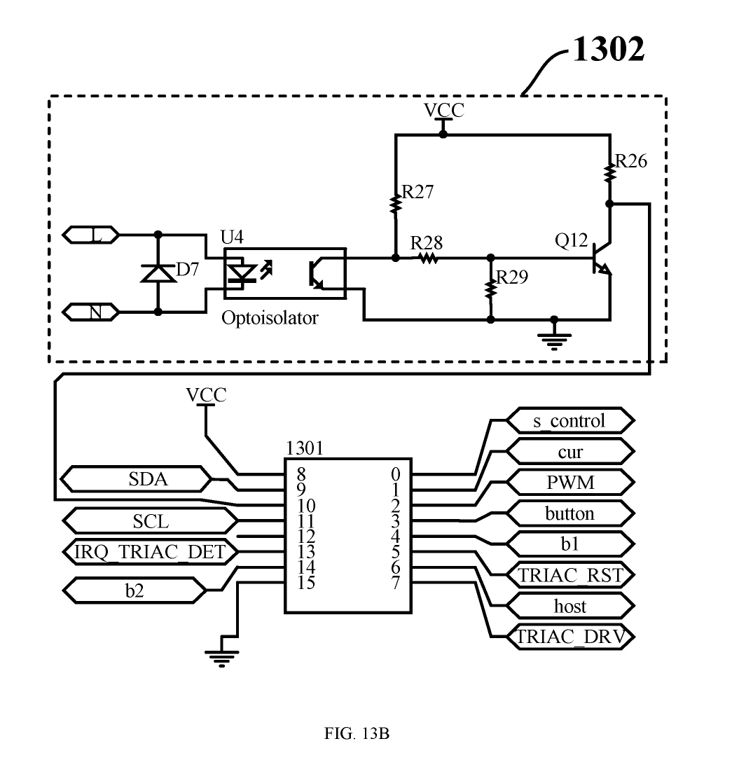

FIG. 13A is a schematic diagram of a first portion of the master controller 110 including the dimmer adaptor 250 according to some embodiments of the present application. FIG. 13B is a schematic diagram of a second portion of the master controller 110 including the dimmer adaptor 250 according to some embodiments of the present application. The pins with the same numbering or notation in FIG. 13A and FIG. 13B refers to the same device or components. Referring to FIG. 13B, the power supply of a positive supply voltage (VCC) may be a DC power source derived from the rectifier circuit 1205. The power supply VCC may drive one or more of the synchronization circuit 1302, the computing circuit 1301, the current detector 1305, and the amplifier 1306. The power signal PWR may drive the regulation circuit 1304. The PWR may be generated from L′ or L, or derived from the rectifier circuit 1205.

The synchronization circuit 1302 may receive an input voltage from one of its terminals, for example, pin 10 as illustrated in FIG. 13B. The synchronization circuit 1302 may include several resistors R26, R27, R28, and R29 to lower the received input voltage. The synchronization circuit 1302 may generate a timing 12g signal based on the input voltage. The timing signal may indicate corresponding zero-crossing points and/or directions (phases) of that input voltage. The timing signal may be transmitted to the computing circuit 1301. Exemplary waveforms of the timing signal are described elsewhere in the present application. See, for example, FIG. 15A through FIG. 15H and the descriptions thereof. For instance, the input voltage may be delivered by a household power source that conducts an AC voltage via two separate live wires with a magnitude of 120 volts and a phase difference of 180 degrees. As shown in FIG. 13B, L may be a first live wire and N may be a null line. A second live wire (L′, not shown in FIG. 13B) may be coupled (or referred to as electrically connected) to an optoisolator U4. The input voltage may be delivered by a power source that conducts an AC current or AC voltage. The optoisolator U4 may include one or more emitting diodes. A diode D7 may reduce the jitter that may occur around the zero-crossing points of the input voltage. D7 may also protect the synchronization circuit 1302 from being damaged by a reverse voltage. The synchronization circuit 1302 may be separated into two parts by the optoisolator U4 for safety considerations. The portion of the synchronization circuit 1302 downstream to optoisolator U4 may be isolated from a high voltage input. The optoisolator U4 may be a resistive optoisolator, a photodiode optoisolator, a phototransistor optoisolator, a bidirectional optoisolator, or the like, or any combination thereof. The negative-positive-negative (NPN) bipolar junction transistor (BJT) Q12 may amplify the output signal from the optoisolator U4. The base of Q12 may be coupled to the output of the optoisolator U4. The collector of Q12 may be coupled to a pin 10 of the computing circuit 1301. Q12 may steepen the rising edge and the falling edge of an output signal, which may reduce the delay of the output signal when the output signal encounters the zero-crossing points. A positive-negative-positive (PNP) BJT, instead of the NPN BJT Q12, may alternatively be utilized to amplify the output signal from the optoisolator U4. It is further understood that one or more parts of or the entire synchronization circuit 1302 may be substituted by or embodied in one or more integrated circuits (ICs).

The computing circuit 1301 may include several pins as FIG. 13B shows. Pin 0 (s_control) may be connected with pin 33 of the amplifier 1306 for providing s_control signal to control a gain of the amplifier 1306. Pin 1 (cur) may be coupled with pin 31 of the amplifier 1306 and receive the detected current from pin 31. The gain may be calculated or controlled by the computing circuit 1301 according to the detected current from the amplifier 1306. Pin 2 (PWM) may be provide a pulse width modulation (PWM) signal. Pin 3 (button) may receive the control signals from, for example, a control panel or the dimmer adaptor 250. Pin 4 (b1) and pin 14 (b2) may be involved in adaptively controlling the holding current of the TRIAC Q4 with two metal oxide semiconductors (MOS) transistors Q5 and Q9 (FIG. 13A). Pin 5 may be used to restart the TRIAC Q4 in case that an error occurs. Pin 6 (host) may be configured to indicate if the control panel is connected properly with the computing circuit 1301 of the dimmer adaptor 250. Pin 7 (TRIAC_DRV) may supply the triggering current to the gate of the TRIAC Q4. Pin 8 may be connected to the positive supply voltage VCC. Pin 9 (SDA), pin 11 (SCL), and pin 13 (terminal IRQ_TRAIC_DET) may be involved in communication with other devices including, for example, a computer. Pin 10 may be connected with the synchronization circuit 1302. Pin 12 may be reserved for any future purposes or uses. For instance, a user may be allowed to define the function of pin 12. In some embodiments, pin 12 may be used to facilitate inter-connection between two dimmer adaptors 250. The inter-connection between dimmer adaptors 250 may allow data transmission (e.g., user input or data relating to the detected current) from one dimmer adaptor 250 to another. The data transmission may be based on, for example, an inter-integrated circuit (I2C) or a universal asynchronous receiver/transmitter (UART) communication. Pin 15 may be connected to a first signal ground. A signal ground may refer to a reference point having a potential different than that of the earth. The above descriptions of the designation of the pins are provided for illustration purposes, and not intended to limit the scope of the present application. It is understood that the designation of the pins and their connection with other portions of the dimmer adaptor 250 or other devices may be revised.

It should be noted that the TRIAC Q4 in the regulation circuit 1304 may be replaced by any other bidirectional semiconductor. Also, the MOS transistor Q5 and/or Q9 may be replaced by any other bidirectional semiconductor. The bidirectional semiconductors may include, for example, an MOS transistor, a bidirectional thyristor diode, a TRIAC, a diode for alternating current (DIAC), a varistor (for example, a metal-oxide varistor (MOV)), a triode, or the like, or any combination thereof.

The computing circuit 1301 may be a processor. The processor may be an IC with a certain number of pins corresponding to, for example, pins 0 through 15. One or more pins of the IC may be coupled with one or more electronic devices. Alternatively, the computing circuit 1301 may be a central processing unit (CPU), an application-specific integrated circuit (ASIC), an application-specific instruction-set processor (ASIP), a graphics processing unit (GPU), a physics processing unit (PPU), a microcontroller unit (MCU), a digital signal processor (DSP), a field programmable gate array (FPGA), an advanced RISC (reduced instruction set computing) machines (ARM), or the like, or any combination thereof. In some embodiments, the computing circuit 1301 may include several timers (not shown in FIG. 13B) built in for counting.

The regulation circuit 1304 may be implemented to adjust the intensity of the power delivered to a load device including, for example, an LED lamp (not shown in FIG. 13A), in response to a control signal for dimming or brightening the LED lamp. The control signal may be from a user operating an adjusting knob, a dial, a slider switch, a touch screen, or other electrical or mechanical devices capable of generating a control signal with multiple adjustment settings. The TRIAC Q4 in the regulation circuit 1304 may generate a phase control power signal that may control the intensity of power delivered to the LED lamp. The TRIAC Q4 may be coupled to a live wire L and a current detector 1305. Two capacitors C1, C2, and a resistor R30 may be coupled with the live wire L and the TRIAC Q4. The capacitors C1 and C2, and the resistor R30 may be connected in parallel. The TRIAC Q4 may chop (cut) the output voltage at a desired conduction angle from the live wire L. A terminal of the TRIAC Q4 may be coupled with the computing circuit 1301 in a different manner. The TRIAC Q4 may be connected to a second signal ground via resistors R19 and R22. The second signal ground may have a potential different from that of the first signal ground. The TRIAC Q4 may have two working modes including a triggering mode and a conduction mode. When the TRIAC Q4 is in the triggering mode, the TRIAC Q4 is nonconductive and the LED lamp is off. To turn on the TRIAC Q4, a triggering current may be supplied to the gate of the TRIAC Q4 to turn the TRIAC Q4 into the conduction mode. Pin 7 (TRIAC_DRV) of the computing circuit 1301 may supply the triggering current to the gate of the TRIAC Q4. The triggering current from TRIAC_DRV may be first input to the optoisolator U6, and then amplified by a NPN BJT Q8. The NPN BJT Q8 may be further connected with two resistors R19 and R20 by four diodes D2, D3, D4, and D5. The amplified triggering current may be supplied to the gate of the TRIAC Q4. After the TRIAC Q4 is turned into the conduction mode, a minimum current may be needed to sustain the conduction of the TRIAC Q4. The minimum current may be referred to as a holding current herein. A thyristor current may refer to the current conducted through a semiconductor device. When the thyristor current through TRIAC Q4 drops below the holding current, the TRIAC Q4 may be turned off. To sustain the conduction of the TRIAC Q4 after it is turned into the conduction mode, the thyristor current may be dynamically monitored through the TRIAC Q4, pin 4 (b1) and pin 14 (b2) of the computing circuit 1301 may be used to adaptively control the holding current of the TRIAC Q4 with two MOS transistors Q5 and Q9. A resistor R12 may connect the TRIAC Q4 with the MOS transistor Q5. Resistors R19 and R20 may connect the TRIAC Q4 with the MOS transistor Q9. The drain of the MOS transistor Q5 may also be connected to the second signal ground via a resistor R15. The gate of the MOS transistor Q5 may be connected to the BJT Q6 via a resistor R13. A Zener diode D1 may connect the gate and the drain of the MOS transistor Q5. The drain of the MOS transistor Q9 may also be connected to the second signal ground via a resistor R24. A Zener diode D6 may connect the gate and the drain of the MOS transistor Q9. The gate of MOS transistor Q9 may be connected to the BJT Q10 via a resistor R21. As used herein, dynamic monitoring may indicate that the monitoring is continuous and/or real time. As used herein, adaptive control may indicate that the conductivity of the TRIAC Q4 may be controlled in real time according to the intensity of the thyristor current through TRIAC Q4. Thus, b1 and b2 may supply a compensating current to the TRIAC Q4 that may sustain the current conducted through the load device 1203 for the purpose of anti-flicker. Terminal TRIAC_RST (pin 5) may be involved in restarting the TRAIC Q4 when an error is detected. One or more pins of the computing circuit 1301 may be configured as TRIAC-RST terminals. Terminal SDA (pin 9), terminal SCL (pin 11), and terminal IRQ_TRAIC_DET (pin 13) may communicate with other devices including, for example, a computer. It should be noted that the above description of the regulation circuit 1304 is provided merely for illustration purposes, and does not intend to limit the scope of the present application. For example, one or more parts of the regulation circuit 1304 may be substituted by one or more ICs.

The computing circuit 1301 may be coupled with a control panel as an input/output interface. In some embodiments, the control panel may include three buttons for dimming controls. One of the three button may be for turning the LED lamp on/off, one may be for dimming, and one may be for brightening. The three buttons may be coupled with pin 3 of the computing circuit 1301. The button (pin 3) of the computing circuit 1301 may be used to receive the control signals from, for example, the control panel or the dimmer adaptor 250. Alternatively, the computing circuit 1301 may have one or more buttons (one or more pins) for receiving control signals from, for example, the control panel or the dimmer adaptor 250. Merely by way of example, the load device 1203 is an LED lamp, and the control signals may include dimming the LED lamp, brightening the LED lamp, turning on/off the LED lamp, or the like, or a combination thereof. A control signal may be inputted via the control panel, the dimmer adaptor 250, or a remote control (not shown in the figure), etc. A control signal may be generated based on an instruction stored in, for example, a computer or another device that may communicate with or be part of the control system 100. Merely by way of example, the instruction may specify a condition and a corresponding control signal to be generated. Exemplary conditions may include the time when a control signal is to be generated, the intensity of ambient light that a control signal is to be generated, the power consumption of a lamp on the basis of which a control signal is to be generated, or the like, or a combination thereof. The control signal may include, for example, a dimming signal to dim the LED lamp, a brightening signal to brighten the LED lamp, an initiation signal to turn on the LED light, a termination signal to turn off the LED lamp, or the like, or any combination thereof. Alternatively, the control signal may be a signal representing a desirable luminous intensity of the LED lamp. For example, the control signal may indicate dimming the LED lamp to a certain luminance, for example, 500 millicandela. Alternatively, the control signal may be a signal relating to a value by which the luminous intensity is measured. For example, if the value of the luminous intensity of the LED lamp falls in the range between 0 and 100 changing in increments of 1, a user may adjust the luminous intensity of the LED lamp to a desired value within the range. For another type of a load device 1203, the control signal may include, for example, a signal to reduce the power to the load device 1203, a signal to increase the power to the load device 1203, an initiation signal to turn on the load device 1203, a termination signal to turn off the load device 1203, or the like, or any combination thereof.

Pin 2 (PWM) of the computing circuit 1301 may provide a PWM signal. The PWM signal may light one or more LED indicators when a corresponding button is pressed. In some embodiments of the present application, the PWM signal may control the intensity of power delivered to the LED lamp. By adjusting the duty cycle of the PWM signal, the computing circuit 1301 may dim or brighten the LED lamp, or turn on/off the LED lamp. As used herein, a duty cycle may refer to the percentage of time in a period in which a signal is active. As used herein, a period may refer to the time it takes for a signal to complete an on-and-off cycle. Pin 6 (host) of the computing circuit 1301 may indicate if a control panel is connected properly with the computing circuit 1301 of the dimmer adaptor 250.

The computing circuit 1301 may be electrically isolated from the regulation circuit 1304 by employing one or more optoisolators. The pins 14 (b2), 7 (TRIAC_DRV), and 4 (b1) of the computing circuit 1301 may be isolated from the regulation circuit 1304 by three optoisolators U3, U6, and U5. The sensors of optoisolators U3 and U5 may be connected to the second signal ground. Resistors R14 and R16 may be connected to the pin 14 and optoisolator U3. Resistors R17 and R18 may be connected to the pin 7 and optoisolator U6. Resistors R23 and R25 may be connected to the pin 4 and the optoisolator U5. The resistors may reduce the amplitude of the currents from pins 14, 7, or 4. The output currents from the optoisolators U3, U6, or U5 may be amplified by three BJTs Q7, Q8, or Q11. The base of BJT Q7 may receive the PWR via a resistor R31. The base of BJT Q11 may receive the PWR via a resistor R32. The emitters of BJTs Q7 and Q11 may be connected to the second signal ground. The optoisolator U3 may be connected with a collector of a BJT Q13 via a resistor R31. The emitting diodes of the optoisolator U3 may be connected to the first signal ground. In some embodiments, the first signal ground may have a potential lower than the potential of the second signal ground. In some embodiments, the first signal ground may be the same as the ground connected to the pins GND 670, 675, 675-1, or 675-2, as shown in FIGS. 6C through 8. Another resistor R30 may connect the collector of BJT Q13 with the emitter of BJT Q13. The emitting diodes of the optoisolator U6 may be connected to the first signal ground. The optoisolator U5 may be connected with a collector of a BJT Q14 via a resistor R32. The emitting diodes of the optoisolator U5 may be connected to the first signal ground. Another resistor R33 may connect the collector of BJT Q14 with the emitter of BJT Q14. During a cycle when the input voltage is applied across the TRIAC Q4, a time interval of conduction may be controlled by a control signal generated from the computing circuit 1301. For instance, when a dimming signal is received by the computing circuit 1301, it may decrease the triggering current transmitted from pin 7 to the TRIAC Q4, and the conduction time may be reduced to a level that an LED lamp may be dimmed according to the desire of a user. The term “conduction time” may refer to the length of the time period in which the TRIAC Q4 remains conductive. If a brightening signal is received by the computing circuit 1301, it may increase the triggering current outputted by pin 7, causing the time within a cycle when the TRIAC Q4 remains conductive to become longer, thereby brightening LED lamp. When the triggering current of TRAIC Q4 remains constant, the luminous intensity of the LED lamp may remain constant (or substantially constant). When a forward phase control power signal is utilized to control the intensity of the power delivered to the LED lamp, the computing circuit 1301 may increase the conduction angle to dim the LED lamp, or decrease the conduction angle to brighten the LED lamp. When a reverse phase control power signal is utilized to control the intensity of power delivered to the LED lamp, the computing circuit 1301 may increase the conduction angle to brighten the LED lamp, or decrease the conduction angle to dim the LED lamp. The conduction angle may be adjusted by the computing circuit 1301. The adjustment may be continuous. The adjustment may be stepwise. For example, the conduction angle may be adjusted to a desired angle including, for example, 0°, 20°, 30°, 40°, 50°, 60°, 70°, 130°, 250°, etc.

The monitoring circuit 1303 may include a current detector 1305 and an amplifier 1306. The TRIAC Q4 may be coupled with terminal FUEL+ (pin 20) of the current detector 1305 via an inductor L1 with magnetic core. The inductor L1 may reduce or eliminate a current spike generated when the TRIAC Q4 is turned to be conductive. The TRIAC Q4 may be coupled with one or more pins of the current detector 1305. The live wire L′ may be coupled with pin 19 of the current detector 1305. The live wire L′ may be coupled with one or more pins of the current detector 1305. An analog signal proportional to the input current may be provided by the current detector 1305. The analog signal may be an analog voltage or an analog current. In some embodiments, the output signal may be a bipolar output signal that duplicates the wave shape of the input current. In some embodiments, the output signal may be a unipolar output signal that is proportional to the average or root mean square (RMS) value of the input current. The current detector 1305 may be an IC. The IC may allow a bandwidth selection by way of, for example, a control input. The bandwidth selection may reduce the noise of the detected intensity of the current to a load device, for example, the LED lamp. For example, the bandwidth selection may be within a range of frequencies from 20 kHz to 80 kHz.

The output signal of the current detector 1305 may be delivered from pin 22 to the amplifier 1306 (pin 26) as an input signal. The amplifier 1306 may amplify the input signal by a desired gain calculated and/or controlled by the computing circuit 1301. The amplifier 1306 may be an integrated operational amplifier (IOA) whose gain terminal may be controlled by the computing circuit 1301. Terminal s_control (pin 33) may be coupled with the computing circuit 1301. The terminal s_control (pin 33) may be involved in controlling the gain of the amplifier 1306. Terminal cur (pin 31) may be coupled with the computing circuit 1301 and may be involved in providing the amplitude of the current detected by the current detector 1305 from pin 22 to pin 1 of the computing circuit 1301. The output current of the amplifier 1306 may be delivered to the computing circuit 1301 for detection and/or adjustment. For example, when the output current of the amplifier 1306 is too weak for an ammeter to measure, the computing circuit 1301 may send a control signal to the gain terminal 33 of the amplifier 1306 such that the amplifier 1306 may increase the output current of the amplifier 1306. As another example, when the output current exceeds a threshold level, the computing circuit 1301 may send a control signal to the gain terminal of the amplifier 1306 which may instruct the amplifier 1306 to reduce the output current. Optionally, the output current of the amplifier 1306 may be sent to the computing circuit 1301 for calculation and/or displaying energy consumption data on a control panel. For example, the control panel may be equipped with an LCD screen on which the energy consumption data may be displayed in a user-defined format. Other types of displays that may be included in the control panel may include, for example, an LED display, an OLED display, an electronic paper display, an electroluminescent display, etc. It should be noted that the amplifier 1306 may be unnecessary, and that the energy consumption data may be received from an amperometer (or referred to as ammeter), a digital amplifier, etc.

The current detector 1305 may include several pins as FIG. 13A shows. Pins 16, 17, 18, 23, and 24 may be reserved for any future purposes or uses. For instance, a user may be allowed to define the function of at least one of pins 16, 17, 18, 23, and 24. Pin 19 (L′) may be connected with the live wire L′. Pin 20 (FUEL+) may be connected with The TRIAC Q4. Pin 21 may be connected to the VCC and maintain a constant potential. Pin 22 may provide an output signal of the current detector 1305 to the amplifier 1306 (pin 26). Pin 25 may be connected to the first signal ground.

The amplifier 1306 may include several pins as FIG. 13A shows. Pin 26 may be connected with pin 22 of the current detector 1305 and receive an input signal. Pins 27, 28, and 32 may be reserved for any future purposes or uses. For instance, a user may be allowed to define the function of at least one of pins 27, 28, and 32. Pin 29 may be connected to the first signal ground. Pin 30 may be connected to the VCC and maintain a constant potential. Pin 31 (cur) may be coupled with pin 1 of the computing circuit 1301 and provide the detected current to the computing circuit 1301. Pin 33 (s_control) may be connected to pin 0 of the computing circuit 1301 and receive an s_control signal to control the gain of the amplifier 1306.

In some embodiments of the present application, the monitoring circuit 1303 may be used to continuously sense the thyristor current through the TRIAC Q4. When the thyristor current through the TRIAC Q4 is below a threshold level, for example, the holding current, the TRIAC Q4 may be turned off, resulting in the flickering of the LED lamp LED 1. By sensing the thyristor current through the TRIAC Q4, the computing circuit 1301 may supply an additional current to the TRIAC Q4 when the intensity of thyristor current through the TRIAC Q4 drops below a threshold level (e.g., the intensity of the holding current). The additional current may be a compensating current. When the decreasing of the thyristor current through the TRIAC Q4 may be sensed by the monitoring circuit 1303. An indicator signal may be generated by the monitoring circuit 1303 and subsequently sent to the computing circuit 1301. Upon receiving the indicator signal, the computing circuit 1301 may supply the compensating current to the TRIAC Q4 via one or more optoisolators, for example, one or more of U3, U5, and U6, along with one or more MOS transistors. By supplying the compensation current, the optoisolator U3, U5 or U6 may keep the TRIAC Q4 conductive.

It should be noted that the monitoring circuit 1303 described above employs a current detection method based on Hall effect. However, it is appreciated that other electromagnetic principles in which the current or any other measurable parameter relating to the current may be utilized in the monitoring circuit 1303. Exemplary electromagnetic principles may include Ohm's law, the electromagnetic induction, the magneto-optic effect, or the like, or a combination thereof. Specifically, the monitoring circuit 1303 may take the form of, for example, a circuit including resistors in series, or a circuit configured to sample current and voltage synchronously, one or more current dividers, one or more current transformers, one or more flux gate current sensors, one or more Rogowski coils, one or more giant magnetoresistance current sensors, one or more magnetostrictive current sensors, one or more fiber optic current sensors, or the like, or a combination thereof.

It should be noted that a computer readable medium storing instructions, executable by the computing circuit 1301, may be provided to perform the operations of the dimmer adaptor 250 including, for example, dimming (if applicable), brightening (if applicable), turning on, or turning off a load device (e.g., a lamp). The computer readable medium may store instructions, when executed, may cause the computing circuit 1301 to determine a conduction angle of a phase control power signal generated from the regulation circuit 1304, a target brightness of an LED lamp, a control signal according to the conduction angle, or the like, or any combination thereof.

Those skilled in the art will recognize that other embodiments may have various circuits other than those described here, and that the functionalities may be distributed among various circuits in any different manner. In addition, the functions ascribed to the various circuits may be performed by multiple circuits.

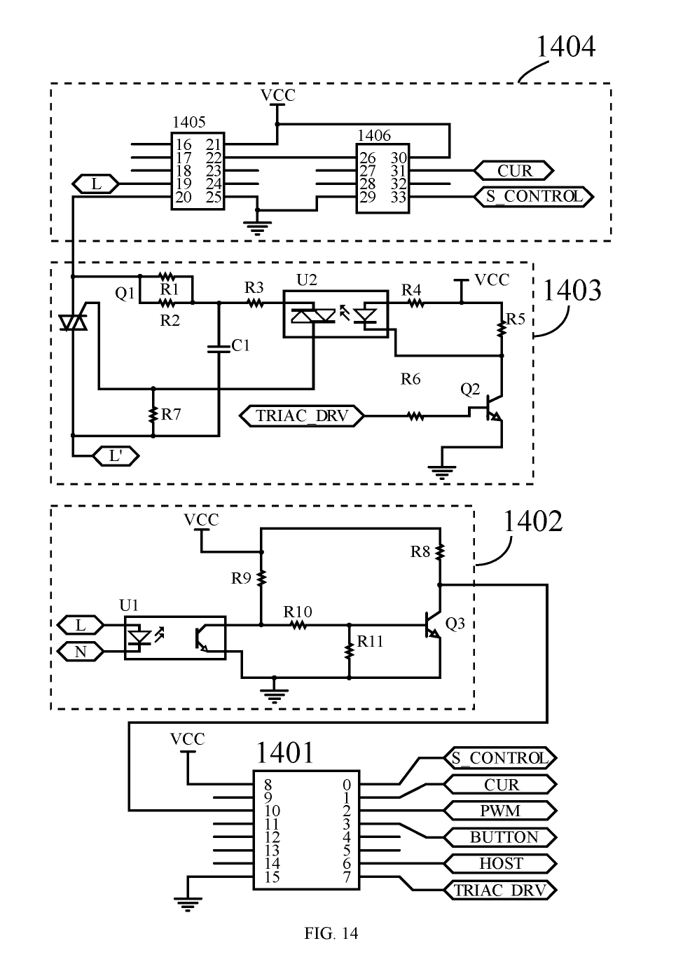

FIG. 14 is a schematic diagram of the master controller 110 according to some embodiments of the present application. The master controller 110 may have several components connected to a third signal ground. In some embodiments, the third signal ground may be the same as the ground connected to pin GND 670, 675, 675-1, or 675-2, as shown in FIGS. 6C through 8. In some embodiments, the third signal ground may be the same as the first signal ground in FIGS. 13A and 13B. In some embodiments, the master controller 110 may be or include a dimmer adaptor or a power regulation circuitry. The pins with the same numbering or notation in FIG. 14 refers to the same device or components. The master controller 110 may include a synchronization circuit 1402, a computing circuit 1401, a regulation circuit 1403, and a monitoring circuit 1404. The synchronization circuit 1402 may include an optoisolator U1, an NPN bipolar junction transistor (BJT) Q3, and one or more resistors. Optionally, a diode may be coupled with the emitting diodes of the optoisolator U1 (not shown in the figure). Particularly, the optoisolator U1 may include one or more emitting diodes. In some embodiments, the anodes of the emitting diodes of the optoisolator U1 may be connected with the live wire L, while the cathodes may be connected with the null line N. When the optoisolator U1 is coupled with one or more diodes, a second live wire L′ (not shown in the figure) may be connected to the optoisolator U1. Alternatively, the diode(s) coupled with the optoisolator may be connected to any power source and allow the current flow in one direction. The optoisolator U1 may be connected to the power VCC via a resistor R9. The NPN BJT Q3 may amplify the output signal of the optoisolator U1. A collector of the NPN BJT Q3 may be connected to the power VCC via a resistor R8. A base of the NPN BJT Q3 may be connected to the optoisolator U1 via a resistor R10. The base of the NPN BJT Q3 may be connected to an emitter of the NPN BJT Q3 via a resistor R11. The emitter of the NPN BJT Q3 may be connected to the third signal ground. Based on the amplified signal, a timing signal may be generated and supplied to the pin 10 of the computing circuit 1401. Exemplary waveforms of the timing signal are shown in FIG. 15F through FIG. 15G. The timing signal may indicate the zero-crossing points of the AC input voltage from the live wire L. The synchronization circuit 1402 may be powered by the VCC generated from the second power supply 1208 (as shown in FIG. 12) or the power supply 1106 (as shown in FIG. 11).

The regulation circuit 1403 may include a TRIAC Q1, an optoisolator U2, an NPN BJT Q2, a plurality of resistors, and a capacitor C1. The TRIAC Q1 may be involved in controlling a load device by generating a phase control power signal. The resistors may include two resistors R1 and R2 in parallel. A resistor R3 may connect the capacitor C1 and the optoisolator U2. A resistor R4 may connect emitting diodes of the optoisolator U2 and the power VCC. A resistor R5 may connect a collector of the NPN BJT Q2 and the power VCC. A resistor R6 may connect the base of NPN BJT Q2 and a Pin 7 (TRIAC_DRV) of computing circuit 1401. An emitter of the NPN BJT Q2 may be connected to the third signal ground. A resistor R7 may connect a gate and an anode of the TRIAC Q1. The port TRIAC_DRV may be connected with the computing circuit 1401 via pin 7.

The computing circuit 1401 may be powered by the VCC. The computing circuit 1401 may have one or more pins. The computing circuit 1401 may include a processor. The processor be an IC with a certain number of pins. One or more pins of the IC may be coupled with one or more electronic devices. Alternatively, the processor may be a central processing unit (CPU), an application-specific integrated circuit (ASIC), an application-specific instruction-set processor (ASIP), a graphics processing unit (GPU), a physics processing unit (PPU), a microcontroller unit (MCU), a digital signal processor (DSP), a field programmable gate array (FPGA), an advanced RISC (reduced instruction set computing) machines (ARM), or the like, or any combination thereof. In some embodiments, the computing circuit 1401 may include several timers (not shown in FIG. 14) built in for counting.

The computing circuit 1401 may be in an electric isolation from the regulation circuit 1403 by employing an optoisolator U2. During a cycle of the input voltage applied across the TRIAC Q1, a conduction time interval may be controlled by a control signal generated from the computing circuit 1401. When the computing circuit 1401 receives a signal to reduce the power to a load device (e.g., a light, an LED lamp, etc.), it may decrease the triggering current transmitted from pin 7 to the TRIAC Q1, and the conduction time may be reduced to a certain level so that the power to the load device is reduced (not shown in the figure). Conversely, if the computing circuit 1401 receives a signal to increase the power to the load device, it may increase the triggering current outputted by pin 7, and the TRIAC Q1 may have a longer conduction time during a cycle which leads to the increase of the power to the load device (or the brightening of the light, the LED lamp, etc.).

It should be noted that the TRIAC Q1 in the regulation circuit 1403 may be replaced by any other bidirectional semiconductor. The bidirectional semiconductors may include, for example, a MOS transistor, a bidirectional thyristor diode, a TRIAC, a DIAC, a varistor (for example, a MOV), a triode, or the like, or any combination thereof.

Merely by way of example, the load device is an LED lamp. When a forward phase control power signal is utilized to control the intensity of power delivered to the LED lamp, the computing circuit 1401 may increase the conduction angle to reduce the conduction time and therefore dim the LED lamp, or decrease the conduction angle to increase the conduction time and brighten the LED lamp. When a reverse phase control power signal is utilized to control the intensity of power delivered to the LED lamp, the computing circuit 1401 may increase the conduction angle to increase the conduction time and brighten the LED lamp, or decrease the conduction angle to reduce the conduction time and dim the LED lamp. The conduction angle may be adjusted by the computing circuit 1301. The adjustment may be continuous. The adjustment may be stepwise. The conduction angle may be adjusted to, for example, 0°, 20°, 30°, 40°, 50°, 60°, 70°, 130°, 250°, or the like.

The computing circuit 1401 may include several pins as FIG. 14 shows. Pin 0 (s_control) may be connected with pin 33 of the amplifier 1406 for providing an s_control signal to control a gain of an amplifier (e.g., the amplifier 1406). Pin 1 (cur) may be coupled with pin 31 of the amplifier 1406 and receive the detected current from pin 31. Pin 2 (PWM) may be for providing a pulse width modulation (PWM) signal. Pin 3 (button) may be used to receive the control signals from, for example, a control panel or the dimmer adaptor 250, etc. Pins 4, 5, 9, 11, 12, 13, and 14 may be reserved for future purposes or uses. For instance, a user may be allowed to define the function of at least one of pins 4, 5, 9, and 11 through 14. Pin 6 (host) may be configured to indicate if the control panel is connected properly with the computing circuit 1401 of the dimmer adaptor 250. Pin 7 (TRIAC_DRV) may allow the triggering current to pass through to the gate of the TRIAC Q4. Pin 8 may be connected to the positive supply voltage VCC. Pin 10 may be connected to synchronization circuit 1402. Pin 15 may be connected to the third signal ground. In some embodiments, the computing circuit 1401 may include several timers (not shown in FIG. 14) built in for counting.

The monitoring circuit 1404 may be coupled with the regulation circuit 1403 via, e.g., the TRIAC Q1. The monitoring circuit 1404 may include a current detector 1405 and an amplifier 1406. The monitoring circuit 1404 may be powered by the VCC. As showed in FIG. 14, the TRIAC Q1 may be coupled with pin 20 of the current detector 1405. The TRIAC Q1 may be coupled with one or more pins of the current detector 1405. The live wire L may be coupled with one or more pins of the current detector 1405. The current detector 1405 may be coupled with the amplifier 1406. For instance, pin 22 of the current detector 1405 may be coupled with pin 26 of the amplifier 1406. An analog signal that relates to the input current may be outputted by the current detector 1405 in the form of an analog voltage or an analog current. The analog signal may change proportionally with the input current. The output signal may be a bipolar output signal or a unipolar output signal. A bipolar output may duplicate the waveform of the input current. A unipolar output signal may be proportional to the arithmetic mean or root mean square (RMS) value of the input current. Furthermore, the current detector 1405 may be an integrated circuit (IC) having a bandwidth selection control input. The use of a shunt ammeter or a feedback ammeter may improve the noise performance. For example, the bandwidth within a frequency range from 20 kHz to 80 kHz may be selected.

The output signal of the current detector 1405 may be delivered as an input signal to the amplifier 1406 (through pin 26). The input signal may be amplified by the amplifier 1406 with a desired gain controlled by the computing circuit 1401. The amplifier 1406 may be an integrated operational amplifier (IOA) whose gain terminal may be controlled by the computing circuit 1401. Terminal s_control may be coupled with the computing circuit 1401. The terminal s_control may be involved in controlling the gain of the amplifier 1406. Terminal cur may be coupled with the computing circuit 1401. The terminal cur may be involved in supplying the current detected by the current detector 1405 to the computing circuit 1401. The output current of the amplifier 1406 may be delivered to the computing circuit 1401 for detecting and adjusting the output current with a controllable gain. For example, when the output current of the amplifier 1406 is too weak to be measured by an ammeter, the computing circuit 1401 may generate a control signal to the gain terminal of the amplifier 1406; the amplifier 1406 may, based on the control signal, amplify the output current. As another example, when the intensity of the output current exceeds a threshold level, the computing circuit 1401 may generate a control signal to the gain terminal of the amplifier 1406; the amplifier 1406 may, based on the control signal, reduce the output current. Energy consumption data may be determined based on the output current of the amplifier 1406. More descriptions regarding the energy consumption may be found in, e.g., PCT Application Publication No. WO2018032514, entitled “Electric power management system and method,” filed on Aug. 19, 2016, which is hereby incorporated by reference. The energy consumption data may be sent to a control panel for displaying. In some embodiments, the control panel may be equipped with an LCD screen and the energy consumption data may be displayed on the LCD screen in a user-defined format. However, other types of displays such as, an LED display, an OLED display, an electronic paper display, an electroluminescent display, and so on, may also be utilized in the control panel.

The current detector 1405 may include several pins as FIG. 14 shows. Pins 16, 17, 18, 23, and 24 may be reserved for any future purposes or uses. For instance, a user may be allowed to define the function of at least one of pins 16, 17, 18, 23, and 24. Pin 19 (L′) may be connected with the live wire L′. Pin 20 (FUEL+) may be connected with the TRIAC Q4. Pin 21 may be connected with the VCC. In some embodiments, the VCC may maintain a constant potential, for example, 7.4 V, 26 V or any other suitable potential. Pin 22 may provide an output signal of the current detector 1405 to the amplifier 1406 (pin 26). Pin 25 may be connected to the third signal ground.

The amplifier 1406 may include several pins as FIG. 14 shows. Pin 26 may be connected with pin 22 of the current detector 1405 and receive an input signal from the current detector 1405. Pins 27, 28, and 32 may be reserved for any future purposes or uses. For instance, a user may be allowed to define the function of at least one of pins 27, 28, and 32. Pin 29 may be connected to the third signal ground. Pin 30 may be connected to the VCC. In some embodiments, the VCC may maintain a constant potential, for example, 7.4 V, 26 V or any other suitable potential. Pin 31 (cur) may be coupled with pin 1 of the computing circuit 1401 and provide the detected current to computing circuit 1401. Pin 33 (s_control) may be connected to pin 0 of the computing circuit 1401 and receive s_control signal to control the gain of amplifier 1406.

It should be noted that a computer readable medium storing instructions executable by the computing circuit 1401 may be provided to conduct the operation of the dimmer adaptor, including adjusting (increasing, decreasing) the power to a load device, turning on or turning off the loading device, etc. The computer readable medium may store instructions for determining a conduction angle of a phase control power signal generated from the regulation circuit 1403, instructions for determining a target power level to a load device, instructions for determining a control signal based on the conduction angle, or the like, or a combination thereof. In some embodiments, the load device may include an LED lamp. In some embodiments, the load device may be another type of device as described elsewhere in the present application.

Those skilled in the art will recognize that other embodiments may have various circuits other than the ones described here, and that functionalities may be distributed among the circuits in a different manner.

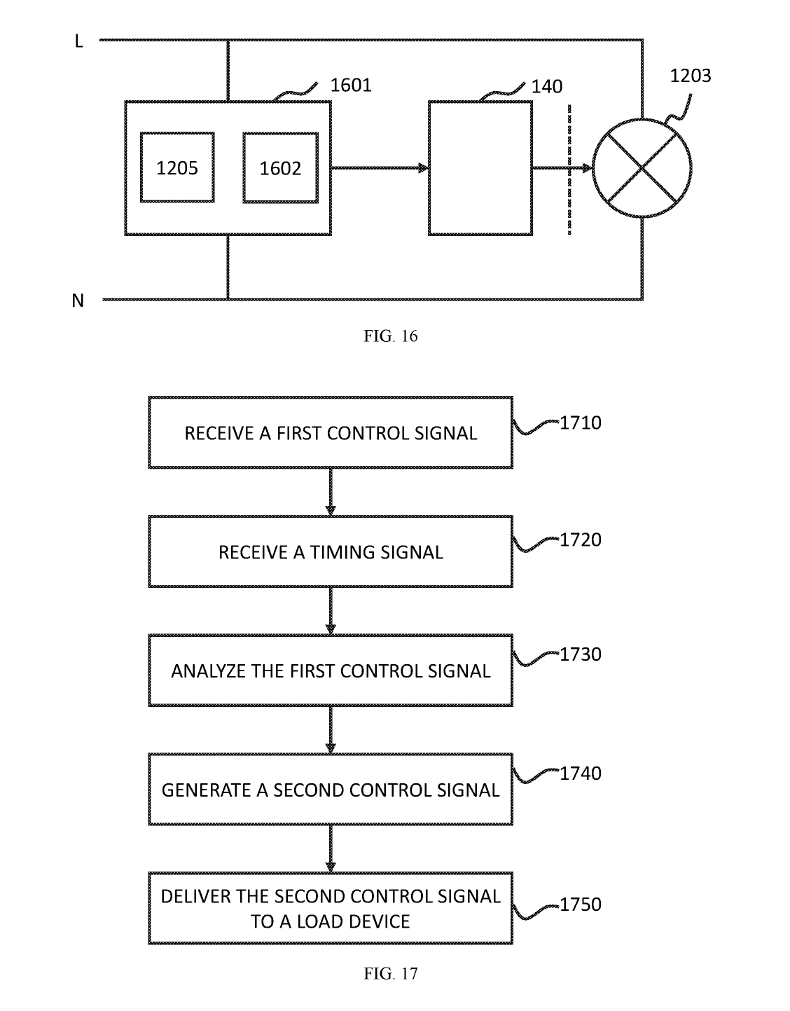

FIG. 15A through FIG. 15E shows exemplary waveforms illustrating the operation of the dimmer adaptor 250 according to some embodiments of the present application. As illustrated in FIG. 15A, Vp may be the waveform of an AC input voltage from, for example, the power module 280, the power source 1201 (FIG. 12), the live wire L (FIG. 13, FIG. 14 and FIG. 16), the live wire L′ (FIG. 13 and FIG. 14), the power source 1101, etc. As illustrated in FIG. 15C, Vs may be the timing signal generated by a synchronization circuit including, for example, the synchronization circuit 1204, the synchronization circuit 1302, the synchronization circuit 1104, the synchronization circuit 1402, or the like, or any combination thereof. The timing signal may be a series of pulse signals with a desired duty cycle that is generated corresponding to the zero-crossing points of Vp regardless of the direction of Vp. In some embodiments, a timing signal may be generated immediately after the occurrence of the zero-crossing point of Vp. In some embodiments, a delay (not shown in the figure) may exist between the occurrence of a zero-crossing point and the timing signal generated in response. The delay may depend on the components employed in the circuit for detecting the occurrence of a zero-crossing point of Vp and generating the time signal in response. The timing signal may be provided for monitoring the status of the Vp. The timing signal may indicate the direction of the zero-crossing points of Vp as specified in FIG. 15C. Upon the reception of a control signal according to, for example, an input from a user, the waveform of Vp may be phase-chopped (cut) at the conduction angle based on the timing signal. As illustrated in FIG. 15D, Vf may be a forward phase control power signal. As illustrated in FIG. 15E, Vr may be a reverse phase control power signal. The conducted waveform of Vf or Vr may be adjusted by increasing or decreasing the conduction angle. Vf, or Vr, or any combination thereof, may be delivered to a load device such as an LED lamp, a CFL, an incandescent lamp, a heater, a motor, etc. for the purpose of controlling the intensity of power.

Merely by way of example, the load device is a lamp. When a brightening signal is received, the conduction angle of Vf may be decreased while the conduction angle of Vr may be increased, in order to increase the intensity of power delivered to the load device. When a dimming signal is received, the conduction angle of Vf may be increased while the conduction angle of Vr may be decreased, in order to decrease the intensity of power delivered to the load device. Vf or Vr, may be generated by, for example, the regulation circuit 1109 in FIG. 11, the regulation circuit 1209 in FIG. 12, the regulation circuit 1304 in FIG. 13, the regulation circuit 1403 in FIG. 14, etc.

In FIG. 15B, Vrc may represent the waveform of a regulated AC input voltage. Vrc may be a half-wave power (indicated by the dash line or the dotted line), or a full-wave power (indicated by the dash line and the dotted line).

In some embodiments, a forward phase control power signal or a reverse phase control power signal may be utilized to control the intensity of power delivered to the load device. In some embodiments of the present application, a PWM signal may be utilized. A PWM signal may include a series of square waves with a fixed period and variable duty cycle. The period of the PWM signal may be variable. Three PWM signals, PWM1, PWM2, and PWM3, are illustrated in FIG. 15F through FIG. 15H. The intensity of the power delivered to the load device may be controlled by adjusting the duty cycle of the PWM signal. For example, PWM1 (in FIG. 15F) is a PWM signal with a 20% duty cycle, PWM2 (in FIG. 15G) with a 55% duty cycle, and PWM3 (in FIG. 15H) with a 90% duty cycle. The PWM signal may be generated by, for example, the computing circuit 1107 in FIG. 11, the computing circuit 1207 in FIG. 12, the computing circuit 1301 in FIG. 13, the computing circuit 1401 in FIG. 14, etc. It should be noted that any other waveform of the PWM signal may be utilized. For example, in some embodiments, the PWM signal may have a positive waveform.

In FIG. 15I, a phase chopping is illustrated according to some embodiments of the present application. For the sake of convenience, a waveform of a sinusoid input voltage in one period is shown. The amplitude of the sinusoid input voltage may be detected by synchronization circuit 1204 continuously or in real time. When the amplitude equals to or is close to zero (0), the synchronization circuit 1204 may output a timing signal indicating the time of zero points. According to a time delay (corresponding to the time interval between the point β to the point μ) whose value may be set by the computing circuit 1207, the regulation circuit 1209 may have its conductivity changed. For example, during the period from the point α (having a phase of 0) to the point μ (having a phase of, for example, 0.7π) and that from the point β (having a phase of π) to the point v (having a phase of, for example, 1.7π), the regulation circuit 1209 may be non-conductive. As a consequence, the regulation circuit 1209 may output no voltage. In FIG. 15I, the corresponding voltage waveforms may be illustrated as two dashed curves 1510 and 1530. And during the period from the point μ to the point β and that from v to y, the regulation circuit 1209 may be conductive. As a consequence, the regulation circuit 1209 may output two voltage waveforms as two solid curves, 1520 from the point μ to the point β and 1540 from v to y, respectively. Thus, the conduction angle in one half-cycle may be 0.3π. In sum, the conduction angle in a full cycle may be 0.6π.

FIG. 16 is a block diagram of a power supply of the dimmer adaptor 250 according to some embodiments of the present application. A power supply 1601 may receive an input power from a power source, for example, from a household live wire as L shown in FIG. 16. The power supply 1601 may receive an AC input voltage from a power source. The power supply 1601 may include a rectifier circuit 1205 (FIG. 12) and a switched-mode power supply 1602. The rectifier circuit 1205 may receive an input voltage from the power source 1201 (FIG. 12). The rectifier circuit 1205 may transform the input voltage from an AC power to a DC power. The output DC power may be either a half-wave or a full-wave power. The output DC power may be supplied to the switched-mode power supply 1602. The switched-mode power supply 1602 may output a desired voltage, for example, 7.4 V, 5 V, 3.3 V, etc. The switched-mode power supply 1602 may include a pulse width modulation (PWM) controller. The switched-mode power supply 1602 may supply power to a control panel. The control panel may include an LCD screen. The control panel may include a touch-screen. Furthermore, the switched-mode power supply 1602 may supply power to a peripheral device of the dimmer adaptor 250. For example, the peripheral device may be a control panel, an alarm, or a vibrator etc. This arrangement, in which the power supply 1601 is in parallel connection with the LED lamp 1203 (FIG. 12), may allow isolation of the LED lamp 1203 from the operation of the power supply 1601.

FIG. 17 is a flowchart illustrating a process for the operations of the dimmer adaptor 250 according to some embodiments of the present application. Initially, the dimmer adaptor 250 may receive a first control signal and a timing signal (in step 1710 and step 1720). The first control signal may be received from one or more peripheral devices, such as, a control panel which is connected with the dimmer adaptor 250 via a connector (for example, a touch screen of the control panel), a remote control device wirelessly connected with the dimmer adaptor 250 (for example, a cellphone, a mobile tag), a mechanical or electronic device (for example, an adjusting knob, a dial, a slider switch, a touch screen) in communication with the dimmer adaptor 250, or the like, or any combination thereof. The timing signal may be received from a synchronization circuit inside the dimmer adaptor 250. The timing signal may notify the dimmer adaptor of the time of the zero-crossing points of an input voltage. In some embodiments, the first control signal and the timing signal may be received simultaneously or essentially simultaneously. In some embodiments, the first control signal and the timing signal may be received sequentially. At step 1730, the dimmer adaptor 250 may analyze the first control signal. The first control signal may indicate increasing the intensity of power delivered to the load device, decreasing the intensity of power delivered to the load device, adjusting the intensity of power delivered to the load device to a certain magnitude, cutting off the power supplied to the load device, initiating the power supplied to the load device, or the like, or any combination thereof. At step 1740, the dimmer adaptor 250 may generate a second control signal (step 1740). The second control signal may be generated based on the first control signal and/or the timing signal. The second control signal may be a forward phase control power signal, a reverse phase control power signal, a PWM signal, a constant current reduction (CCR) signal, or the like, or any combination thereof. The second control signal may be delivered to a load device and the intensity of power delivered to the load device may be adjusted in response to the second control signal.

Although in FIG. 17, the first control signal may be received prior to the reception of the timing signal, in some embodiments, the timing signal may be received before the first control signal. Alternatively, the timing signal may be received with the first control signal simultaneously. Thus the acts in step 1710 may be conducted after or simultaneously with those in step 1720.

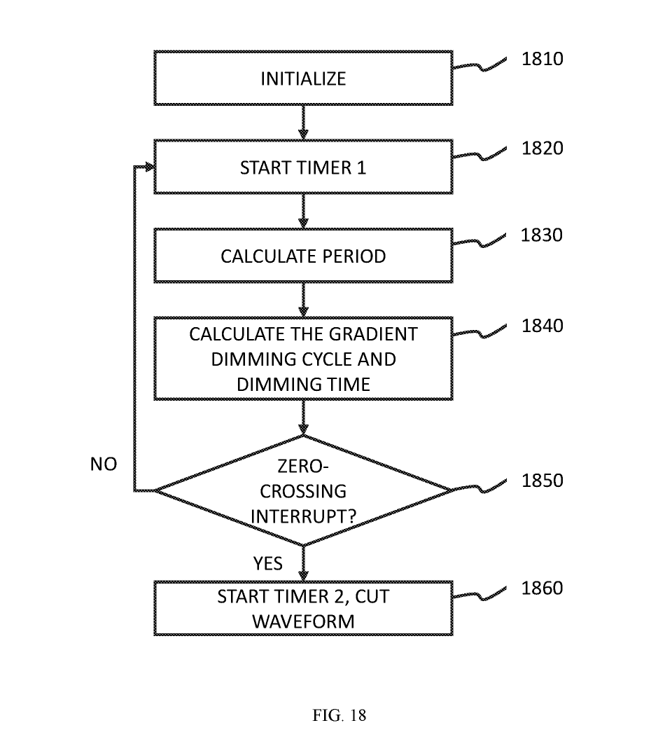

FIG. 18 is a flowchart illustrating a process for controlling a load device (e.g., an LED lamp) according to some embodiments of the present application. In step 1810, an initialization may be performed. The initialization may include providing power to a processor (e.g., an MCU), setting up the triggering mode of zero-crossing interrupt, etc. The zero-crossing interrupt may be configured to process a timing signal that may be generated by the synchronization circuit 1204 that is described elsewhere in the present application.

In step 1820, timer 1 1212 may be started. Timer 1 1212 may be a built-in timer of the computing circuit 1207. It should be noted that a similar timer may also be embedded in the computing circuit, for example, the computing circuit 1107, the computing circuit 1301, or the computing circuit 1401. Timer 1 1212 may be configured to track the waveform corresponding to an AC current and/or an AC voltage. The waveform may be a sine waveform, a square waveform, a triangular waveform, a saw-tooth wave, etc. Merely by way of example, the triggering mode of the zero-crossing interrupt may be configured to be rising edge triggering; in a period of the waveform, an interrupt function may be triggered. Every time the interrupt function is triggered, timer 1 1212 may increase by 1. For example, if the value of the timer 1 1212 is N, it may indicate that N periods of the waveform have passed. The triggering mode of the zero-crossing interrupt may be configured as falling edge triggering. In some embodiments, the period of the waveform may be calculated in step 1830 by Equation (1) as follows:

$$T = \frac{n}{N} {T}_{1} , \qquad ( 1 )$$

where T may denote the period of the waveform, Ti may denote time interval of two adjacent countings of timer 1 1212, N may denote the cycle counting of the timer 1 1212 indicating the number of periods that have passed, n may denote the cycle counting of timer 1 1212.

In step 1840, the gradient adjustment cycle and adjustment time may be calculated. If the load device is a light (e.g., an LED lamp), the gradient adjustment cycle may be referred to as a gradient dimming cycle; the adjustment time may be referred to as a dimming time; the magnitude of the power to a load device may be referred to or relate to the luminous intensity. The following description of FIG. 18 may be provided in an exemplary context that the load device is a light. In some embodiments of the present application, the luminous intensity may be divided into a number of levels, for example, L₁ (level 1), L₂ (level 2), L₃ (level 3), L₄ (level 4), L₅ (level 5), etc. In some embodiments, the number of levels corresponding to luminous intensities may be defined by a user. A level may indicate a unique luminous intensity. The dimming time of a level may indicate the rendering time of a TRIAC in a period of the waveform. Merely by way of example, a dimming period may be denoted as t_{d}, and the maximum luminous intensity may be defined as L (level). If the desired dimming level is L1 (assuming L1<L), the dimming time t, in which the TRIAC is rendered conductive, needs to be determined. According to some embodiments of the present application, the dimming time t may be calculated by Equation (2) as follows:

$$t = \frac{{L}_{1}}{L} {t}_{d} . \qquad ( 2 )$$

It should be noted that the description of the dimming time t is merely provided for the purposes of illustration, and not be intended to limit the scope of the present application. Various variations and modifications conducted under the teaching of the present application do not depart from the scope of the present application. As an example, the dimming period t_{d} may be set to be T, T/2, T/4, T/6, T/8, T/16, T/32, etc.

The gradient dimming cycle t_{L} may indicate the time for the luminous intensity to change from one level to another, for example, from L1 to L2. In some embodiments of the present application, t_{L} may be transformed into a number of required half-cycles. Taking the transition from L1 to L2 as an example, the number of half-cycles of a waveform to accomplish t_{L} may be first calculated by Equation (3) as follows:

$$Count = [ \frac{{t}_{L}}{{t}_{d}} ] . \qquad ( 3 )$$

The number of half-cycles may be indicated by Count in the above equation.

To change the luminous intensity from L₁ to L₂ within t_{L}, various schemes may be designed, for example, a linear process, a logarithm-linear process, or the like, or a combination thereof. It should be noted that the above schemes are merely provided for illustration purposes, other schemes, in which the changes of the two luminous intensities in adjacent half-cycles may be the same or different, may also be proposed without departing from the principles of the present application.

As for the linear scheme, the luminous intensity variation in every half-cycle may be calculated based on the gradient dimming cycle by Equation (4) as follows:

$$Δ L = \frac{{L}_{2} - {L}_{1}}{Count} , \qquad ( 4 )$$

where ΔL may indicate the change of the luminous intensity in a half-cycle. Therefore, in the first half-cycle, the target luminous intensity L_{des} may be L₁+ΔL, a dimming time may be derived from L_{des} based on a correlation, for example, the correlation expressed in Equation (2). In every one of one or more half-cycles, the luminous intensity may increase by L_{des} until the luminous intensity of L₂ is reached.

It should be noted that the description of the gradient dimming cycle is provided for the purposes of illustration, and not intended to limit the scope of the present application. Variations and modifications conducted under the teaching of the application may still fall in the scope of the present application. As an example, the number of half-cycles may be calculated by Equation (5) as follows:

$$Count = [ \frac{{t}_{L}}{{t}_{d}} ] + 1 , \qquad ( 5 )$$

where the square brackets “[ ]” denotes an integer function, e.g., the nearest integer function.

As another example, as for the logarithm scheme, the change of luminous intensity in a half-cycle may be calculated by Equation (6) as follows:

$$Δ L = \frac{L ( i + 1 )}{L ( i )} = {e}^{\frac{1}{Count} ( ln {L}_{2} - ln {L}_{1} )} . \qquad ( 6 )$$

Therefore, in the first half-cycle, the target luminous intensity L_{des} may be L₁*ΔL, a dimming time may be derived from L_{des} based on a correlation, for example, the correlation expressed in Equation (2). In every one of one or more half-cycles, the luminous intensity may increase by L_{des} until the luminous intensity of L₂ is reached.

It should be still noted that the approximation method (scheme) utilized to approximate a change of the luminous intensity from one level to another may be a linear, exponential, or any other suitable manner. The functions utilized to approximate the change may include a linear function, a polynomial function, a trigonometric function, an anti-trigonometric function, an exponential function, a power function, a logarithmic function, or the like, or any combination (for example, addition, subtraction, multiplication or quotient between two or more functions) thereof.

In step 1850, whether a zero-crossing interrupt is triggered or not is determined. If a zero-crossing interrupt is triggered, a second timer, denoted as timer 2 1213 as shown in FIG. 12, may be initialized to chop the waveform in step 1860. Timer 2 1213 may be a built-in timer of the computing circuit 1207. It should be noted that a similar timer may also be embedded in the computing circuit, for example, the computing circuit 1107, the computing circuit 1301, or the computing circuit 1401, etc. If on zero-crossing interrupt is triggered, the process from step 1820 to 1850 may repeat.

It should be noted that the flowchart described herein is provided for the purposes of illustration, and not intended to limit the scope of the present application. For those skilled in the art, multiple variations and modifications may be conducted under the teaching of the present application, however, those variations and modifications do not depart from the scope of the present application.

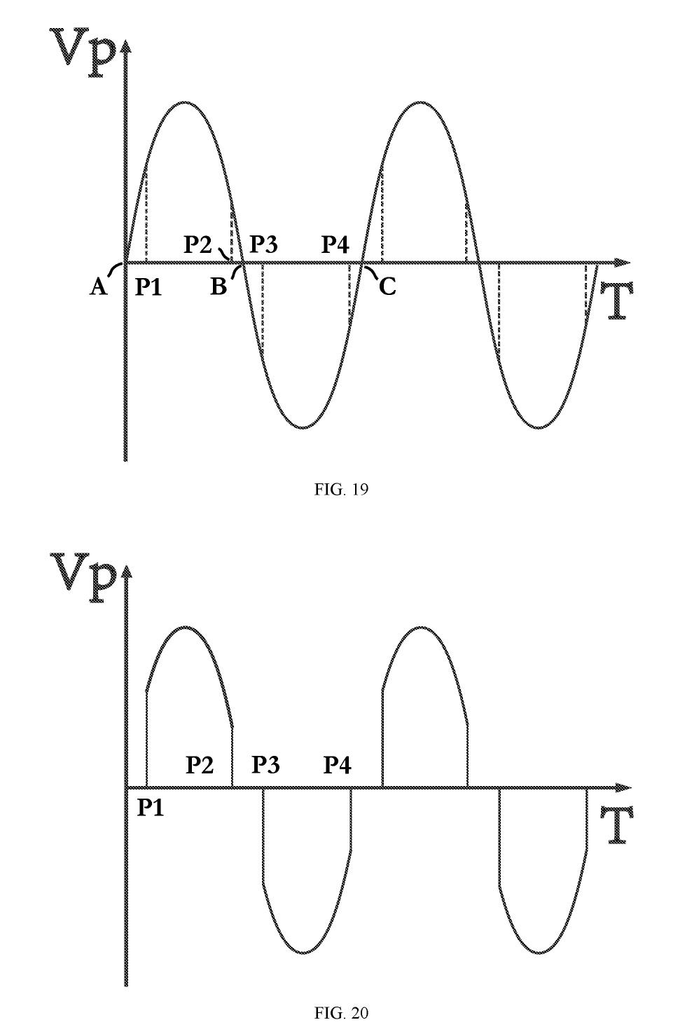

FIG. 19 illustrates a sinusoid waveform of an AC voltage and/or an AC current that may be provided to a load device according to some embodiments of the present application. The AC voltage and/or an AC current may have a sine waveform. Alternatively, the AC voltage and/or the AC current may have a triangular waveform and/or a square waveform. When the sine waveform is delivered to a load device completely within a period, the load device may receive the maximum power (e.g., luminous intensity in the case that the load device is a light). When a variation of the power is desired, the sine waveform may be processed so that a portion of the sine waveform may be chopped off, which may lead to a variation of the power delivered by the AC voltage and/or the AC current corresponding to the sine waveform. In some embodiments of the present application, the sine waveform may be processed by the regulation circuit 1209 (as in FIG. 12), the regulation circuit 1304 (as in FIG. 13), the regulation circuit 1403 (as in FIG. 14), etc. The TRIAC of a dimmer circuit mentioned above may be utilized to process the sine waveform.

To process an AC waveform, the regulation circuit 1209, the regulation circuit 1304, or the regulation circuit 1403 may need to be rendered conductive within a portion of a period of time, while non-conductive in another portion. Here the period of time may be just one (1) period of a sinusoid or cosinusoid waveform, or multiple periods of a sine or cosine waveform. Therefore, the critical times, in which the circuit transit from a conductive state to a non-conductive state, or vice versa, may need to be determined. According to some embodiments of the present application, in one single period, four critical time points may be scheduled, dividing the whole period into five phases, the circuit having different conductivities in adjacent phases. As illustrated in FIG. 19, four points (P1, P2, P3, P4) may be set to control the time to process the sine waveform in a single period, specifically the time rendering the TRIAC Q4 in FIG. 3A or Q1 in FIG. 14 conductive or non-conductive. Merely by way of example, at point P1, the TRAIC Q4 or Q1 may be rendered conductive and the sine waveform may be delivered to the load device. At point P2, the TRAIC Q4 or Q1 may be rendered non-conductive and the sine waveform may be blocked from the load device. The processing of the sine waveform at point P3 may be the same as that at point P1, while the processing of the sine waveform at point P4 may be the same as that of at point P2. It should be noted that the controlling of the TRIAC Q4 or Q1 may be performed by a computing circuit, for example, the computing circuit 1107, the computing circuit 1207, the computing circuit 1301, the computing circuit 1401, etc. Merely by way of example, the computing circuit 1401 may be equipped with a general-purpose input/output (GPIO) which may perform the function of controlling the on/off of the TRIAC Q4 or Q1. GPIO may include a serial general purpose input/output, a programmed input/output, a special input/output designated to perform specialized functions or have specialized features, etc.

The time interval from point P1 to point P2 and that from point P3 to point P4 may be calculated based on the desired power (or the luminous intensity in the case that the load device is a light). One or more of the points P1, P2, P3, and P4 may be adjusted to adjust the time interval from point P1 to point P2 and that from point P3 to point P4. In some embodiments of the present application, the time interval from point P2 to the subsequent zero-crossing point B on the falling edge (which may have a phase of π) may be fixed to a predetermined value, for example, 1 microsecond, 2 microsecond, 3 microsecond, etc. In some embodiments, the point P2 may coincide with the zero-crossing point B. Likewise, the time from point P4 to its subsequent zero-crossing point C (which may have a phase of 2π) may be fixed, for example, 1 microsecond, 2 microsecond, 3 microsecond, etc. In some embodiments, the point P4 may coincide with the zero-crossing point C. Thus, the two points P2 and P4 may be fixed. It should be noted that the time interval from point P2 to the subsequent zero-crossing point B on the falling edge and that from point P4 to its subsequent zero-crossing point C may be different. Regarding the time from point P1 to point P2, as point P2 is fixed, the time interval from point P1 to point P2 may be adjusted by adjusting point P1. Similarly, the time interval from point P3 to point P4 may be adjusted by adjusting point P3.

In some embodiments, the time interval from point P1 to the preceding zero-crossing point A on the rising edge (which has a phase of 0) may be fixed to a predetermined value, for example, 1 microsecond, 2 microsecond, 3 microsecond, etc. Likewise, the time from point P3 to its preceding zero-crossing point B (which has a phase of π) may be fixed. The points P1 and P3 may be fixed. The time interval from point P1 to point P2 may be adjusted by adjusting point P2. Similarly, the time interval from point P3 to point P4 may be adjusted by adjusting point P4.

It should be noted that although the above description of the setting of the points P1, P2, P3 and P4 is provided merely for illustration purposes, and not intended to limit the scope of the present application. For those skilled in the art, various modifications or variations may be made. For example, the group of P1 and P2, and that of P3 and P4, may be adjusted concurrently or jointly.

In some embodiments of the present application, the time of the four points P1, P2, P3, P4 may be calculated by Equation (7) through Equation (10), respectively:

$$\begin{matrix}{t}_{P 1} = \frac{T}{2} - t ; & ( 7 ) \\ {t}_{P 2} = \frac{T}{2} - τ ; & ( 8 ) \\ {t}_{P 3} = \frac{T}{2} + \frac{T}{2} - t = T - t ; & ( 9 ) \\ {t}_{P 4} = \frac{T}{2} + \frac{T}{2} - τ = T - τ ; & ( 10 )\end{matrix}$$

where, t is denoted as the length of time duration between the point P1 and the zero-crossing point B. And T is denoted as the time interval between the point P2 and the zero-crossing point B.

The period of the sine waveform T may depend on the frequency of the AC current and/or the AC voltage. For instance, if the frequency of the AC voltage is 50 Hz, T may be 20 microseconds. As another example, if the frequency of the AC voltage is 60 Hz, T may be approximately 17 microseconds.

After some portions are chopped off, the resulting AC voltage may have a waveform as shown in FIG. 20. Namely, within one period, only during the portions from P1 to P2 and that from P3 to P4, there may be a current through the circuit to the load device; in the other portions of the same period, there may be no current or power to the load device.

It should be noted that the setting or configuration of P1, P2, P3 and P4 may be different, according to different schemes. In some embodiments, the time τ may depend on the electrical characteristics of components in the circuit, and may have any suitable value, for example, 1 microsecond, 2 microseconds, 3 microseconds, etc. In some embodiments, other values may be used for different frequencies of the AC voltage/current or other purposes. Similarly, the value of time t may be predetermined by the manufacturer, or the user. As another example, the number of points for a control of the sine waveform may be defined by the user.

It should be noted that the above mentioned steps in FIG. 17 are provided for illustration purpose. To those skilled in the art, various modifications and variations may be made by adding or removing any appropriately desired amount of steps. However, these modifications and variations are still within the scope of the present application. For example, step 1730 in FIG. 17 may be removed so that the second control signal is generated once the first control signal and the timing signal are received.

It should be noted that the dimmer adaptor 250 may further include one or more TRIACs in parallel or series, and some of the TRIACs may be utilized to adjust the intensity of the power delivered to a particular load device jointly or independently.

It should also be noted that the dimmer adaptor 250 may include one or more dimmer circuits in parallel or series, and at least some of the dimmer circuits may be configured to control the intensity of power delivered to a particular load device jointly or independently.

It should also be noted that the dimmer adaptor 250 may include one or more monitoring circuits, and at least some of the monitoring circuits may be configured to monitor the thyristor current through the dimmer circuit described elsewhere in the present application.

As further noted, the dimmer adaptor 250 may include one or more synchronization circuits, and at least some of the synchronization circuits may be configured to generate a timing signal with respect to a power source.

It should be noted that those skilled in the art may conceive other applications, modifications and/or changes in the disclosure described above. In some embodiments, several dimmer adaptors 250 may coordinate to control multiple lights or other load devices. The coordination may be facilitated by a wired or wireless connection, for example, an electric wire, or a wireless network.

Multiple dimmer adaptors 250 may form a serial connection, a parallel connection, or a combination thereof. The coordination of multiple dimmer adaptors 250 may achieve the control of one or multiple load devices without conflict. In some embodiments, a first dimmer adaptor and a second dimmer adaptor may be in series. The first dimmer adaptor may control the on/off state of the second dimmer adaptor. The second dimmer adaptor may control the on/off state and power supply of a load device, for example, a LED lamp. In some embodiments, two or more dimmer adaptors 250 may be in parallel. The two or more dimmer adaptors 250 may control a load device at the same time. In some embodiments, a first dimmer adaptor may control the on/off state of a second and third dimmer adaptors. The second dimmer adaptor and the third dimmer adaptor may be in parallel and control the on/off state and power supply of the load device. In some embodiments, if the control signal of the load device from the second dimmer adaptor and the control signal of the same load device from the third dimmer adaptor are inconsistent, the load device may report the inconsistency to the user or the master controller 110, authenticate the origins of the control signals, or execute a more recent one between or among the multiple control signals.

In some embodiments, multiple dimmer adaptors 250 may be connected to each other by a wireless network. The wireless network may be a WLAN or Wi-Fi network, a Bluetooth network, an NFC communication, an infrared communication, a Z-wave network, or a ZigBee network. The wireless connection may facilitate the data transmission (e.g., user input or data relating to the detected current) from one dimmer adaptor 250 to another. The data transmission may allow a seamless and convenient control of the load device.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure, and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures or characteristics may be combined as suitable in one or more embodiments of the present disclosure.

Further, it will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “block,” “module,” “engine,” “unit,” “component,” or “system.” Furthermore, aspects of the present disclosure may take the form of a computer program product embodied in one or more computer readable media having computer readable program code embodied thereon.

A computer readable signal medium may include a propagated data signal with computer readable program code embodied therein, for example, in baseband or as part of a carrier wave. Such a propagated signal may take any of a variety of forms, including electro-magnetic, optical, or the like, or any suitable combination thereof. A computer readable signal medium may be any computer readable medium that is not a computer readable storage medium and that may communicate, propagate, or transport a program for use by or in connection with an instruction execution system, apparatus, or device. Program code embodied on a computer readable signal medium may be transmitted using any appropriate medium, including wireless, wireline, optical fiber cable, RF, or the like, or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB. NET, Python or the like, conventional procedural programming languages, such as the “C” programming language, Visual Basic, Fortran 2003, Perl, COBOL 2002, PRP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose, and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution—e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, embodiments lie in less than all features of a single foregoing disclosed embodiment.

In some embodiments, the numbers expressing quantities of ingredients, properties, and so forth, used to describe and claim certain embodiments of the application are to be understood as being modified in some instances by the term “about,” “approximate,” or “substantially.” For example, “about,” “approximate,” or “substantially” may indicate ±20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference for all purposes, excepting any prosecution file history associated with same, any of same that is inconsistent with or in conflict with the present document, or any of same that may have a limiting affect as to the broadest scope of the claims now or later associated with the present document. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the application disclosed herein are illustration of the principles of the embodiments of the application. Other modifications that may be employed may be within the scope of the application. Thus, by way of example, but not of limitation, alternative configurations of the embodiments of the application may be utilized in accordance with the teachings herein. Accordingly, embodiments of the present application are not limited to that precisely as shown and described.

1. A power regulation circuitry comprising:
a regulation circuit connecting a power supply to a load device, the regulation circuit comprising an optoisolator and a bidirectional semiconductor; and
a computing circuit configured to generate a first control signal when a current conducted through the bidirectional semiconductor is below a threshold level, wherein
the optoisolator is configured to
receive the first control signal from the computing circuit; and
supply a compensating current to the bidirectional semiconductor to keep the bidirectional semiconductor conductive, and
the bidirectional semiconductor is configured to receive, from the optoisolator, a second control signal generated by the computing circuit in response to an input relating to a power delivered to the load device.

2. The power regulation circuitry of claim 1, the power supply comprising an alternating current (AC) power source.

3. The power regulation circuitry of claim 1, the computing circuit being powered by an independent power source other than the power supply.

4. The power regulation circuitry of claim 1, the bidirectional semiconductor comprising a triode for alternating current (TRIAC).

5. The power regulation circuitry of claim 1, the load device comprising an electric light.

6. A control system comprising:
a master controller comprising a power regulation circuitry of claim 1.

7. The control system of claim 6, the master controller comprising a rectifier circuit configured to regulate an AC input voltage generated from an AC power source.

8. The control system of claim 7, the master controller comprising a synchronization circuit configured to generate a timing signal indicating a periodicity of an AC input voltage generated by the AC power source.

9. The control system of claim 6, the master controller comprising a monitoring circuit configured to monitor the current conducted through the bidirectional semiconductor.

10. The control system of claim 9, the monitoring circuit being configured to amplify the current conducted through the bidirectional semiconductor by a gain.

11. The control system of claim 6 comprising a first slave controller being electrically connected to the master controller and configured to
receive the input; and
relay the input to the master controller.

12. The control system of claim 11, the master controller comprising a connection module connecting the master controller and the first slave controller.

13. The control system of claim 12, the connection module comprising a first pin and a second pin, wherein the first pin being configured to provide power to the first slave controller and the second pin being configured to establish a connection with the first slave controller.

14-16. (canceled)

17. The control system of claim 11, comprising a second slave controller being electrically connected to the first slave controller and configured to,
receive the input; and
relay the input to the first slave controller.

18. The control system of claim 6, the master controller comprising an input/output interface configured to receive the input from a user.

19. The control system of claim 18, the input/output interface comprising an indicator lamp or a display.

20. (canceled)

21. A method comprising:
connecting a power supply to a load device by a regulation circuit comprising an optoisolator and a bidirectional semiconductor;
receiving an input indicating a power delivered to the load device;
generating a first control signal indicative of a compensating current when a current through the bidirectional semiconductor is below a threshold level;
generating a second control signal indicative of a conduction angle of a phase control power signal in response to the input; and
generating the phase control power signal for controlling the power delivered to the load device according to the second control signal.

22. The method of claim 21 further comprising monitoring the current through the bidirectional semiconductor.

23. The method of claim 22 further comprising amplifying the current through the bidirectional semiconductor with a gain.

24. The method of claim 21 further comprising supplying the compensating current to the bidirectional semiconductor in response to the first control signal.
